(19) United States
(12) Patent Application Publication
(10) Pub. No.: US 2026/0192562 A1
(43) Pub. Date: Jul. 9, 2026

(54) Liquid Ejecting Head

(71) Applicant: SEIKO EPSON CORPORATION, Tokyo (JP)

(72) Inventors: Kenta ONO, Shiojiri (JP); Makoto OTSUKI, Matsumoto (JP)

(21) Appl. No.: 19/441,437

(22) Filed: Jan. 6, 2026

(30) Foreign Application Priority Data
Jan. 7, 2025 (JP) 2025-002168

(51) Int. Cl. B41J 2/045; B41J 2/14; B41J 2/16

(52) U.S. Cl. CPC B41J 2/0451; B41J 2/14201; B41J 2/1623; B41J 2/04581; B41J 2002/14419; B41J 2002/14491; B41J 2202/03; B41J 2202/04

(57) ABSTRACT

A liquid ejecting head includes: a first flow path member that constitutes a first flow path; a second flow path member that constitutes a second flow path; a bonding portion that bonds the first flow path member and the second flow path member such that the first flow path and the second flow path are in communication; and a conductive wire that is disposed at an interface between the first flow path member and the bonding portion so as to be spaced apart from the first flow path.

The present application is based on, and claims priority from JP Application Serial Number 2025-002168, filed Jan. 7, 2025, the disclosure of which is hereby incorporated by reference herein in its entirety.

### BACKGROUND

### 1. Technical Field

The present disclosure relates to a liquid ejecting head.

### 2. Related Art

In the related art, a liquid ejecting head that ejects liquid such as ink from a nozzle is widely used. For example, JP-A-2023-100338 discloses that a plurality of flow path members constituting a flow path of a liquid ejecting head are joined to each other with an adhesive, thereby liquid-tightly coupling flow paths formed in the plurality of joined flow path members.

The adhesive joining the flow path members deteriorates upon contact with liquid flowing through the flow path, and the liquid in the flow path may leak out from a bonded portion to an outside of the flow path members. However, in the related art mentioned above, there is a problem in that a user of the liquid ejecting head cannot determine when the liquid ejecting head should be replaced.

### SUMMARY

According to a preferred aspect of the present disclosure, there is provided a liquid ejecting head including: a first flow path member that constitutes a first flow path communicating with a nozzle that ejects liquid; a second flow path member that constitutes a second flow path communicating with the first flow path; a bonding portion that bonds the first flow path member and the second flow path member such that the first flow path and the second flow path are in liquid-tight communication; and a first conductive wire that is disposed at a first interface between the first flow path member and the bonding portion so as to be spaced apart from the first flow path.

### BRIEF DESCRIPTION OF THE DRAWINGS

FIG. 1 is a schematic diagram showing a configuration example of an ink jet system according to a first embodiment.

FIG. 2 is a diagram showing a configuration of a processing apparatus.

FIG. 3 is a block diagram showing a configuration example of an ink jet printer.

FIG. 4 is a configuration diagram of the ink jet printer.

FIG. 5 is an exploded perspective view of a liquid ejecting head.

FIG. 6 is a cross-sectional view of the liquid ejecting head taken along line VI-VI in FIG. 5.

FIG. 7 is an enlarged view of a vicinity of an ink hole shown in FIG. 6.

FIG. 8 is a cross-sectional view of a head unit taken along an X-axis direction through a wiring hole.

FIG. 9 is a plan view schematically showing an inside of the head unit.

FIG. 10 is a plan view exemplifying an in-structure flow path.

FIG. 11 is a side view of an in-structure supply flow path and an in-structure discharge flow path.

FIG. 12 is a side view of an in-structure supply flow path and an in-structure discharge flow path.

FIG. 13 is a view illustrating a detection mechanism.

FIG. 14 is a view illustrating the detection mechanism.

FIG. 15 is a view illustrating the detection mechanism.

FIG. 16 is a diagram showing a function of the ink jet system.

FIG. 17 is a diagram showing a flowchart showing an operation of the ink jet system.

FIG. 18 is a view illustrating a detection mechanism in a second embodiment.

FIG. 19 is a view illustrating the detection mechanism in the second embodiment.

FIG. 20 is a view illustrating a detection mechanism in a third embodiment.

FIG. 21 is a view illustrating the detection mechanism in the third embodiment.

FIG. 22 is a diagram showing a function of an ink jet system in a fourth embodiment.

FIG. 23 is a view illustrating a detection mechanism in the fourth embodiment.

FIG. 24 is a view illustrating the detection mechanism in the fourth embodiment.

FIG. 25 is a view illustrating a detection mechanism in a first modification example.

FIG. 26 is a view illustrating the detection mechanism in the first modification example.

FIG. 27 is a view illustrating a detection mechanism in a second modification example.

FIG. 28 is a view illustrating the detection mechanism in the second modification example.

FIG. 29 is a view illustrating a detection mechanism in a third modification example.

FIG. 30 is a view illustrating the detection mechanism in the third modification example.

### DESCRIPTION OF EMBODIMENTS

Hereinafter, embodiments for implementing the present disclosure will be described with reference to the drawings. Note that, in the drawings, dimensions and scales of each portion are made different from actual ones as appropriate. In addition, since embodiments to be described below are preferred specific examples of the present disclosure, various technically preferable limitations are imposed. However, the scope of the present disclosure is not limited to these embodiments unless there is a description in the following description that particularly limits the present disclosure.

Hereinafter, for convenience of description, one direction along an X-axis from any point will be referred to as an X1 direction, and a direction opposite to the X1 direction will be referred to as an X2 direction. The X1 direction and the X2 direction are collectively referred to as a direction along the X-axis. Similarly, directions opposite to each other along a Y-axis from any point will be referred to as a Y1 direction and a Y2 direction, and directions opposite to each other along a Z-axis from any point will be referred to as a Z1 direction and a Z2 direction. The Y1 direction and the Y2 direction are collectively referred to as a direction along the Y-axis. The Z1 direction and the Z2 direction are collectively referred to as a direction along the Z-axis. The direction along the X-axis and the direction along the Y-axis are orthogonal to each other. The direction along the X-axis and the direction along the Z-axis are orthogonal to each other. The direction along the Y-axis and the direction along the Z-axis are orthogonal to each other. An X-Y plane including the X-axis and the Y-axis corresponds to a horizontal plane. The Z-axis is an axis along a vertical direction, the Z1 direction corresponds to an upper side in the vertical direction, and the Z2 direction corresponds to a lower side in the vertical direction. Additionally, viewing in the direction along the Z-axis may be referred to as “plan view”.

### 1. First Embodiment

### 1-1. Overview of Ink Jet System SYS

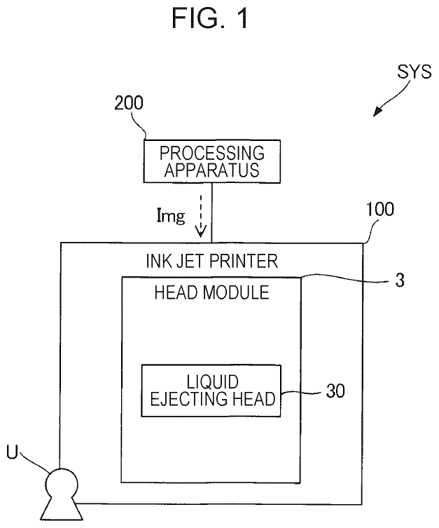

FIG. 1 is a schematic diagram showing a configuration example of an ink jet system SYS according to a first embodiment. The ink jet system SYS is a system that provides a service of forming an image on a medium PP, which will be described below, by using an ink jet method. The ink jet system SYS includes an ink jet printer 100 and a processing apparatus 200.

Here, the ink jet printer 100 is an apparatus provided by a manufacturer of the ink jet printer 100. The ink jet printer 100 is a liquid ejecting apparatus that ejects ink, which is an example of liquid. The manufacturer of the ink jet printer 100 is a company that manufactures the ink jet printer 100. The manufacturer of the ink jet printer 100 may be referred to as a “printer manufacturer”. A liquid ejecting head 30 incorporated into the ink jet printer 100 is provided by a manufacturer of the liquid ejecting head 30. The manufacturer of the liquid ejecting head 30 is a company that manufactures the liquid ejecting head 30. Hereinafter, the manufacturer of the liquid ejecting head 30 may be referred to as a “head manufacturer”. The printer manufacturer receives provision of the liquid ejecting head 30 from the head manufacturer and manufactures the ink jet printer 100 by incorporating the provided liquid ejecting head 30 into the ink jet printer 100. The ink jet printer 100 is an example of a “liquid ejecting apparatus”.

FIG. 1 shows a user U who uses the ink jet printer 100. As the user U, for example, when an operator belonging to the printer manufacturer uses the ink jet printer 100, this operator is the user U. In addition, for example, when a third party who receives the provision of the ink jet printer 100 from the printer manufacturer uses the ink jet printer 100, this third party is the user U. The user U uses the processing apparatus 200 in addition to the ink jet printer 100.

The ink jet printer 100 receives image data Img indicating an image from the processing apparatus 200. The ink jet printer 100 forms an image based on the image data Img on the medium PP. Hereinafter, a process of forming an image on the medium PP may be referred to as a “printing process”.

The ink jet printer 100 includes one head module 3 including one liquid ejecting head 30.

The processing apparatus 200 is a computer such as a desktop type or a notebook type. The processing apparatus 200 may be provided as a part of the ink jet printer 100.

### 1-2. Concerning Failure of Liquid Ejecting Head 30

The liquid ejecting head 30 provided in the ink jet printer 100 may fail because of aging deterioration or the like. One reason for failure of the liquid ejecting head 30 is that a bonding portion that bonds two flow path members constituting a flow path in the liquid ejecting head 30 to liquid-tightly couple flow paths of the two flow path members may come into contact with ink for a long period of time, thereby undergoing either or both of deterioration due to wear caused by a flow velocity or the like and deterioration due to elution of an adhesive into the ink caused by attack by the ink. Consequently, the flow paths of the two flow path members cannot be liquid-tightly coupled, and ink may leak out of the flow path from a location where liquid-tight coupling is no longer possible. Hereinafter, a case where the adhesive can no longer seal a gap between the flow paths of the two flow path members may be referred to as “seal failure”. When seal failure occurs, ink may leak out of the flow path from a location where the seal failure occurs. When ink leaks out of the flow path, the ink may adhere to an electronic circuit in the liquid ejecting head 30 to cause failure, or an inside or a periphery of the ink jet printer 100 may become contaminated with the ink.

Accordingly, there is provided a liquid ejecting head 30 capable of detecting a sign of ink leakage from the liquid ejecting head 30, before the liquid ejecting head 30 fails because of ink leaking out of the flow path from the location where seal failure occurs. The sign of ink leakage from the liquid ejecting head 30 includes that ink will soon leak from the liquid ejecting head 30, and estimation of a lifetime of the liquid ejecting head 30, that is, estimation of a time point at which ink will leak from the liquid ejecting head 30. In the first embodiment, it is assumed that one of the ink and the adhesive has conductive properties and the other has insulating properties.

### 1-3. Configuration of Processing Apparatus 200

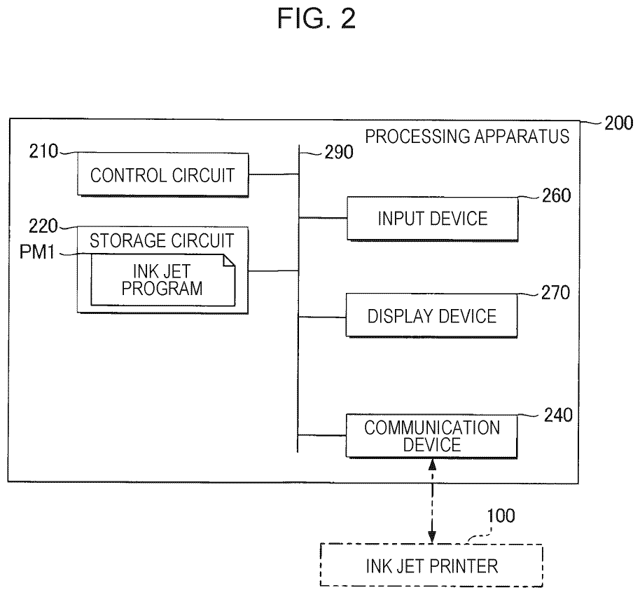

FIG. 2 is a diagram showing a configuration of the processing apparatus 200. The processing apparatus 200 includes a control circuit 210, a storage circuit 220, a communication device 240, an input device 260, and a display device 270. The control circuit 210, the storage circuit 220, the communication device 240, the input device 260, and the display device 270 are mutually connected by a bus 290 for information communication.

The control circuit 210 includes, for example, one or more processors such as a central processing unit (CPU). The control circuit 210 may include a programmable logic device such as a field-programmable gate array (FPGA) instead of the CPU or in addition to the CPU.

The storage circuit 220 is configured with a magnetic storage device, a flash ROM, or the like. The storage circuit 220 is readable by the control circuit 210 and stores a plurality of programs including an ink jet program PM1 executed by the control circuit 210, various kinds of information used by the control circuit 210, and the like. The storage circuit 220 includes, for example, semiconductor memories of one or both of one or more volatile memories, such as a RAM, and one or more non-volatile memories, such as a ROM, an EEPROM, or a PROM. The ink jet program PM1 is, for example, a program for generating the image data Img.

The communication device 240 is a circuit that can communicate with the ink jet printer 100. For example, the communication device 240 is a network card, such as a Universal Serial Bus (USB) or Bluetooth. USB and Bluetooth are registered trademarks.

The input device 260 is a device that outputs operation information corresponding to an operation of the user U. The input device 260 is, for example, a mouse and a keyboard.

The display device 270 displays an image indicating some kind of information to the user U. The display device 270 is an organic electro-luminescence (EL) display, a light emitting diode (LED) display, and a liquid crystal display (LCD). Additionally, the input device 260 and the display device 270 may be configured integrally. A configuration in which the input device 260 and the display device 270 are integral is, for example, a touch panel.

### 1-4. Overview of Ink Jet Printer 100

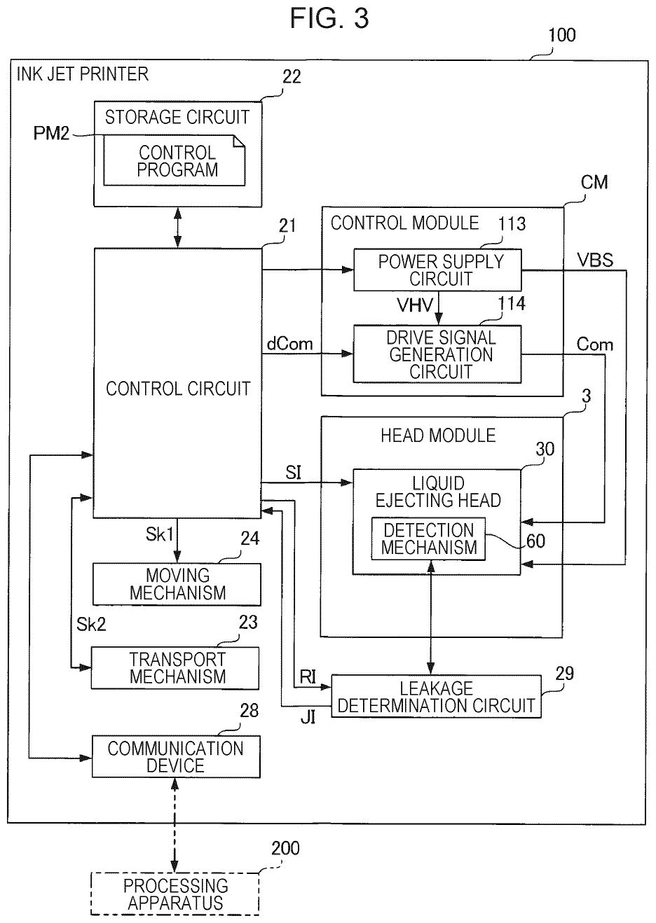

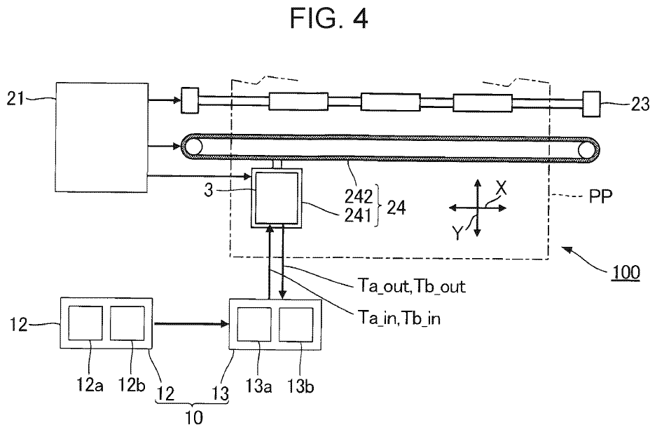

FIG. 3 is a block diagram showing a configuration example of the ink jet printer 100. FIG. 4 is a configuration diagram of the ink jet printer 100. The ink jet printer 100 shown in FIG. 4 is an ink jet type printing apparatus that ejects ink as droplets onto the medium PP. The ink is an example of “liquid”. The medium PP is, for example, printing paper. However, the medium PP is not limited to printing paper and may be, for example, a printing target of any material, such as a resin film or fabric.

As shown in FIGS. 3 and 4, the ink jet printer 100 includes a control module CM, a liquid supply system 10, a control circuit 21, a storage circuit 22, a transport mechanism 23, a moving mechanism 24, the head module 3, a communication device 28, and a leakage determination circuit 29.

The control module CM includes a power supply circuit 113 and a drive signal generation circuit 114. The power supply circuit 113 receives supply of electric power from a commercial power source (not shown) and generates various predetermined potentials. The various generated potentials are supplied to each portion of the ink jet printer 100 as appropriate. In the example shown in FIG. 3, the power supply circuit 113 generates a power supply potential VHV and an offset potential VBS.

The offset potential VBS is supplied to the liquid ejecting head 30. Additionally, the power supply potential VHV is supplied to the drive signal generation circuit 114 and the like.

The drive signal generation circuit 114 is a circuit that generates a drive signal Com for driving the liquid ejecting head 30. Specifically, the drive signal generation circuit 114 includes, for example, a DA conversion circuit and an amplification circuit. In the drive signal generation circuit 114, the DA conversion circuit converts a waveform designation signal dCom, which will be described below, from the control circuit 21 from a digital signal into an analog signal, and the amplification circuit generates the drive signal Com by amplifying the analog signal using the power supply potential VHV from the power supply circuit 113.

The liquid supply system 10 includes a liquid container 12 and a sub tank 13. The liquid container 12 stores ink. The sub tank 13 temporarily stores ink supplied from the liquid container 12.

The liquid container 12 includes, for example, a cartridge that is attachable to and detachable from the ink jet printer 100, a bag-shaped ink pack formed of a flexible film, or an ink tank capable of being refilled with ink. The liquid container 12 includes liquid containers 12a and 12b. For example, different color inks are stored in the liquid containers 12a and 12b. A first ink is stored in the liquid container 12a. For example, a second ink having a color different from that of the first ink is stored in the liquid container 12b.

The sub tank 13 includes sub tanks 13a and 13b. The sub tank 13a is coupled to the liquid container 12a and temporarily stores the first ink. The sub tank 13b is coupled to the liquid container 12b and temporarily stores the second ink. In addition, a supply tube Ta in and a discharge tube Ta out are coupled to the sub tank 13a. A supply tube Tb in and a discharge tube Tb out are coupled to the sub tank 13b. These tubes are coupled to the head module 3. Such a sub tank 13 supplies ink to the head module 3 and collects ink from the head module 3. Accordingly, ink circulates between the sub tank 13 and the head module 3.

The ink is, for example, an aqueous pigment ink, a solvent ink, or an ultraviolet curable ink. The solvent ink is an ink containing an organic solvent. The solvent ink is an ink in which, after being applied to the medium PP, the organic solvent penetrates into the medium PP to form a receiving layer, and a color material is fixed on the receiving layer. The ultraviolet curable ink is an ink containing an ultraviolet curable component. Hereinafter, the ultraviolet curable ink will be referred to as an ultraviolet (UV) ink. The ultraviolet curable component contains a monomer or an oligomer. The UV ink is ink in which, after being applied to the medium PP, the ultraviolet curable component is cured by irradiation with ultraviolet rays, and a color material is fixed in a coating formed by curing of the ultraviolet curable component.

The storage circuit 22 stores various programs including a control program PM2 executed by the control circuit 21 and various kinds of data such as the image data Img processed by the control circuit 21. The storage circuit 22 includes, for example, semiconductor memories of one or both of one or more volatile memories, such as a RAM, and one or more non-volatile memories, such as a ROM, an EEPROM, or a PROM.

The storage circuit 22 may be configured as a part of the control circuit 21.

The transport mechanism 23 transports the medium PP along the Y-axis under the control of the control circuit 21.

The moving mechanism 24 reciprocates the head module 3 along the X-axis under the control of the control circuit 21.

The moving mechanism 24 includes a substantially box-shaped support 241 that accommodates the head module 3, and an endless belt 242 to which the support 241 is fixed.

The communication device 28 is a circuit that can communicate with the processing apparatus 200. For example, the communication device 28 is a network card, such as USB or Bluetooth. In addition, the communication device 28 may be integrated with the control circuit 21.

The head module 3 ejects ink supplied from the sub tank 13 onto the medium PP under the control of the control circuit 21. An image is formed on the surface of the medium PP by ejecting the ink to the medium PP from the head module 3 in parallel with the transport of the medium PP by the transport mechanism 23 and the repetitive reciprocation of the support 241 by the moving mechanism 24. Ink not ejected from the head module 3 is discharged to the sub tank 13. The head module 3 includes one liquid ejecting head 30, but may include a plurality of liquid ejecting heads 30.

The description returns to FIGS. 3 and 4. The control circuit 21 controls each element provided in the ink jet printer 100. The control circuit 21 includes, for example, one or more of processing circuits, such as a CPU or an FPGA, and one or more of storage circuits, such as a semiconductor memory.

The control circuit 21 controls the operation of each portion of the ink jet printer 100 by executing a program stored in the storage circuit 22. Here, the control circuit 21 generates signals such as a control signal Sk1, a control signal Sk2, a print signal SI, a waveform designation signal dCom, and a request signal RI as signals for controlling the operation of each portion of the ink jet printer 100.

The control signal Sk1 is a signal for controlling driving of the moving mechanism 24. The control signal Sk2 is a signal for controlling driving of the transport mechanism 23. The print signal SI is a signal for controlling driving of the liquid ejecting head 30. The waveform designation signal dCom is a digital signal for defining a waveform of the drive signal Com generated by the drive signal generation circuit 114.

The leakage determination circuit 29 executes a leakage determination process of determining whether or not there is a sign of ink leakage from the liquid ejecting head 30 by using a detection mechanism 60 provided in the liquid ejecting head 30. The request signal RI is a signal for requesting the leakage determination circuit 29 to execute the leakage determination process.

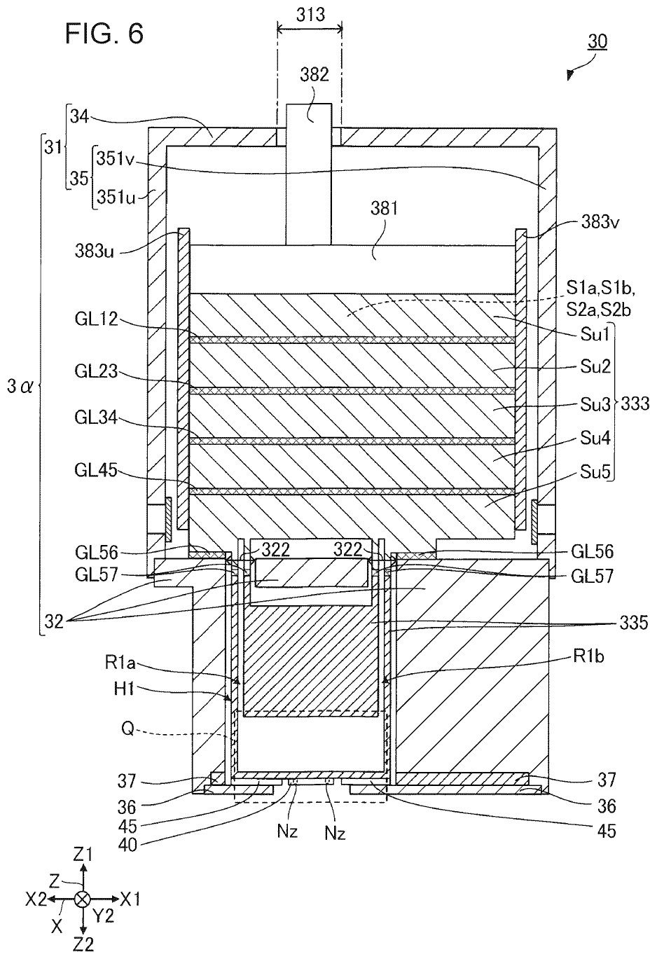

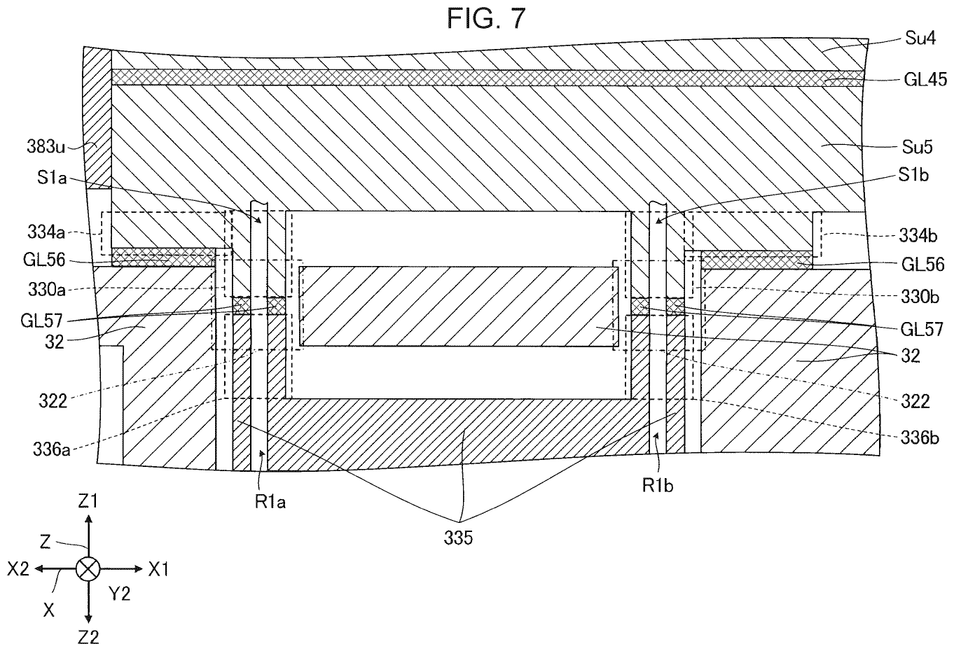

The leakage determination circuit 29 transmits determination information JI indicating an execution result of the leakage determination process to the control circuit 21. The detection mechanism 60 will be described below with reference to FIGS. 13, 14, and 15, and illustration and description thereof are omitted in FIGS. 6 and 7.

### 1-5. Overall Configuration of Liquid Ejecting Head 30

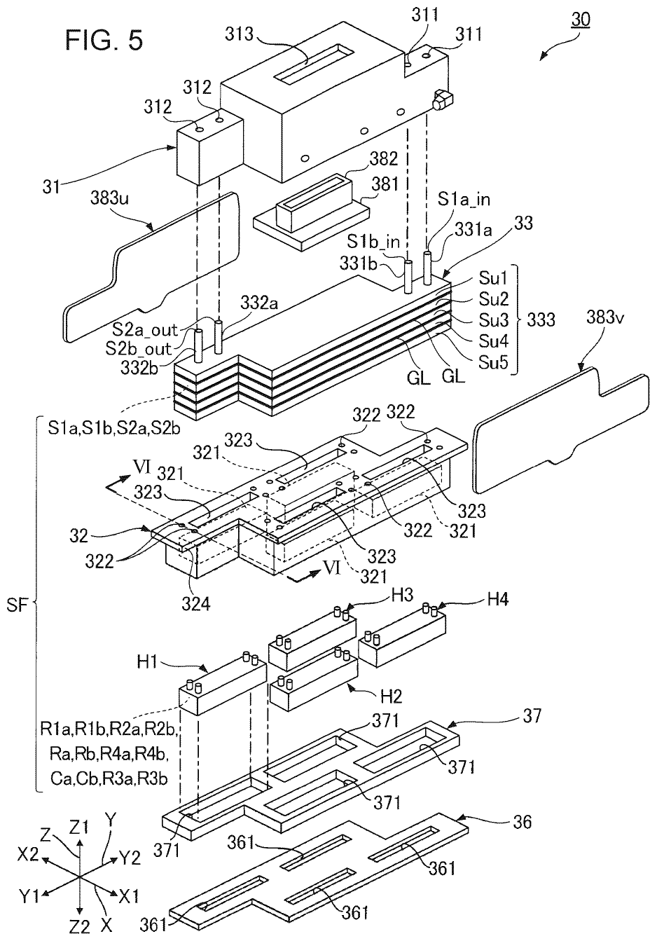

FIG. 5 is an exploded perspective view of the liquid ejecting head 30. FIG. 6 is a cross-sectional view of the liquid ejecting head 30 taken along line VI-VI in FIG. 5. The view shown in FIG. 6 is a view of a cross-section of the liquid ejecting head 30 taken along line VI-VI as viewed in the Y2 direction. The line VI-VI is an imaginary line segment passing through two ink holes 322 and along the X-axis direction.

As shown in FIG. 5, the liquid ejecting head 30 includes a housing 3x, a flow path structure 33, a fixing plate 36, and a reinforcing plate 37. Additionally, the liquid ejecting head 30 includes a plurality of head units H1, H2, H3, and H4. The head units H1, H2, H3, and H4 are referred to as a head unit Hn unless otherwise distinguished. In addition, the liquid ejecting head 30 includes electrical elements such as a wiring substrate 381, a wiring member 382, and circuit boards 383u and 383v. Further, the flow path structure 33 includes a laminate 333, supply coupling portions 331a and 331b, and discharge coupling portions 332a and 332b. Hereinafter, each element provided in the liquid ejecting head 30 will be described with reference to FIGS. 5 and 6.

The housing 3x shown in FIGS. 5 and 6 is a hollow case that accommodates the head unit Hn and the laminate 333. The housing 3x includes a cover member 31 and a holder member 32.

The cover member 31 accommodates the laminate 333. The holder member 32 accommodates the plurality of head units Hn. In the present embodiment, the holder member 32 accommodates four head units Hn. The holder member 32 is disposed in the Z2 direction with respect to the cover member 31.

As shown in FIG. 5, the cover member 31 includes two first coupling portion holes 311, two second coupling portion holes 312, and a first hole 313. The first hole 313 is a hole through which the wiring member 382 is inserted. One of the supply coupling portions 331a and 331b is inserted through and fitted into each first coupling portion hole 311. One of the discharge coupling portions 332a and 332b is inserted through and fitted into each second coupling portion hole 312.

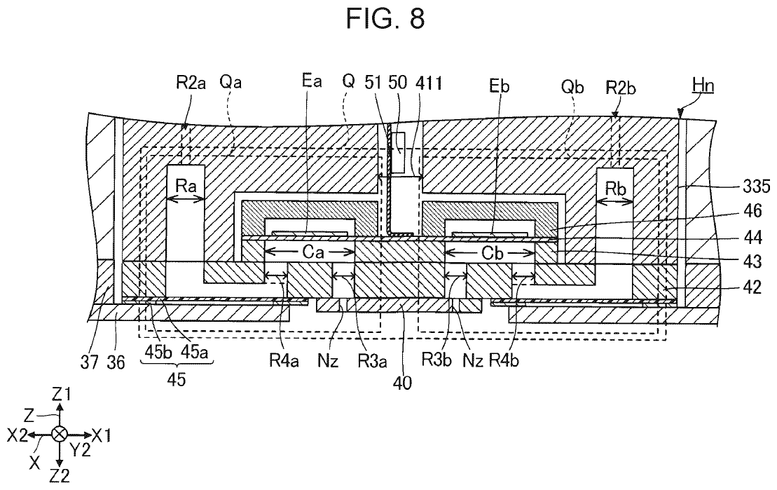

The holder member 32 includes a plurality of recessed portions 321, a plurality of ink holes 322, and a plurality of wiring holes 323. Each recessed portion 321 is a depression that is open in the Z2 direction. The head unit Hn is disposed in each recessed portion 321. Each ink hole 322 is a hole through which ink flows between the flow path structure 33 and the head unit Hn. Each wiring hole 323 communicates with the recessed portion 321. Each wiring hole 323 is a hole through which a flexible substrate 51 shown in FIG. 8 is passed. The flexible substrate 51 is provided for each head unit Hn and is electrically coupled to the head unit Hn. In addition, as shown in FIG. 5, the holder member 32 includes a flange 324 for fixing the holder member 32 to the support 241.

As shown in FIG. 6, the housing 3x includes an upper wall portion 34 and a side wall portion 35. The side wall portion 35 includes a side wall 351u and a side wall 351v.

As shown in FIG. 5, the laminate 333 of the flow path structure 33 includes a plurality of flow path plates Su1, Su2, Su3, Su4, and Su5, and the plurality of flow path plates Su1, Su2, Su3, Su4, and Su5 are referred to as a flow path plate Su unless otherwise distinguished. Each flow path plate Su is formed by, for example, injection molding of a resin, but may also be formed of a metal.

The flow path plates Su1 to Su5 are bonded to each other by an adhesive that forms bonding portions GL12, GL23, GL34, and GL45. The flow path plate Su5 is bonded in the Z1 direction to the holder member 32 by an adhesive that forms a bonding portion GL56. In the following description, a layer formed by an adhesive in the liquid ejecting head 30 is collectively referred to as a bonding portion GL. The bonding portion GL liquid-tightly couples two members. An adhesive forming the bonding portion GL is, for example, an epoxy-based adhesive containing an epoxy resin as a main component, but may also be a silicone-based adhesive or the like.

The liquid ejecting head 30 includes a flow path SF communicating with the nozzle Nz inside. The flow path SF includes in-structure supply flow paths S1a and S1b, in-structure discharge flow paths S2a and S2b, in-head supply flow paths R1a and R1b, in-head discharge flow paths R2a and R2b, a first liquid storage chamber Ra, a second liquid storage chamber Rb, second communication flow paths R4a and R4b, pressure chambers Ca and Cb, and first communication flow paths R3a and R3b.

The laminate 333 includes the in-structure supply flow paths S1a and S1b and the in-structure discharge flow paths S2a and S2b. The in-structure supply flow paths Sla and S1b and the in-structure discharge flow paths S2a and S2b are referred to as an in-structure flow path Sn unless otherwise distinguished. Each in-structure flow path Sn is a space formed in the laminate 333. The ink flows through the in-structure flow path Sn. Each in-structure flow path Sn is formed by one or both of grooves along an XY plane provided in each of two flow path plates Su adjacent to each other, and a hole in the flow path plate Su that extends in the Z-axis direction. In FIG. 6, the in-structure flow path Sn is not shown in order to prevent the drawing from being complicated.

Specifically, the in-structure supply flow path S1a supplies the first ink stored in the sub tank 13a to the plurality of head units Hn. The in-structure supply flow path S1b supplies the second ink stored in the sub tank 13b to the plurality of head units Hn. The in-structure discharge flow path S2a discharges the first ink that is not ejected from the plurality of head units Hn to the sub tank 13a. The in-structure discharge flow path S2b discharges the second ink that is not ejected from the plurality of head units Hn to the sub tank 13b. Filter portions Fa and Fb including filters that capture foreign matter or bubbles mixed into ink may be installed in the in-structure flow paths Sn.

Each of the supply coupling portions 331a and 331b and the discharge coupling portions 332a and 332b is provided in the Z1 direction with respect to the laminate 333 and protrudes from the laminate 333 in the Z1 direction. Each of the supply coupling portions 331a and 331b and the discharge coupling portions 332a and 332b is a coupling tube for communication between each in-structure flow path Sn and the outside of the housing 3x.

Specifically, the supply coupling portion 331a is a supply tube through which the first ink is supplied from the sub tank 13a to the in-structure supply flow path Sla, and is provided with a supply port S1a in for supplying the first ink to the laminate 333. The supply coupling portion 331b is a supply tube through which the second ink is supplied from the sub tank 13b to the in-structure supply flow path S1b, and is provided with a supply port S1b in for supplying the second ink to the laminate 333. The discharge coupling portion 332a is a discharge tube through which the first ink is discharged from the in-structure discharge flow path S2a to the sub tank 13a, and is provided with a discharge port S2a out for discharging the first ink from the laminate 333. The discharge coupling portion 332b is a discharge tube through which the second ink is discharged from the in-structure discharge flow path S2b to the sub tank 13b, and is provided with a discharge port S2b out for discharging the second ink from the laminate 333.

The head unit Hn includes the in-head supply flow paths R1a and R1b, the in-head discharge flow paths R2a and R2b, and a liquid ejecting portion Q that ejects ink. The first liquid storage chamber Ra, the second liquid storage chamber Rb, the second communication flow paths R4a and R4b, the pressure chambers Ca and Cb, and the first communication flow paths R3a and R3b are provided in the liquid ejecting portion Q. The flow paths provided in the liquid ejecting portion Q are shown in FIG. 8.

In FIG. 6, the detailed shape of the liquid ejecting portion Q is not shown in order to prevent the drawing from being complicated. The detailed shape of the liquid ejecting portion Q will be described below with reference to FIG. 8. As shown in FIG. 6, each head unit Hn includes a plurality of nozzles Nz. Each nozzle Nz is a through-hole for ejecting ink in the Z2 direction. Specifically, each head unit Hn includes a plurality of nozzles Nz that eject the first ink and a plurality of nozzles Nz that eject the second ink. Additionally, each head unit Hn defines the in-head supply flow paths R1a and R1b and the in-head discharge flow paths R2a and R2b.

The in-head supply flow paths R1a and R1b are flow paths from an end portion of the head unit Hn in the Z1 direction to the liquid ejecting portion Q. The in-head discharge flow paths R2a and R2b are flow paths from the liquid ejecting portion Q to the end portion of the head unit Hn in the Z1 direction. The in-head supply flow paths R1a and R1b and the in-head discharge flow paths R2a and R2b are referred to as an in-head flow path Rn unless otherwise distinguished.

The head unit Hn includes a case 335 that defines the in-head flow path Rn.

FIG. 7 is an enlarged view of a vicinity of the ink hole 322 shown in FIG. 6. The flow path plate Su5 includes columnar projecting portions 334a and 334b protruding in the Z2 direction. The projecting portions 334a and 334b are bonded in the Z1 direction to the holder member 32 by an adhesive forming the bonding portion GL56.

The flow path plate Su5 includes flow path plate side communication tubes 330a and 330b. The flow path plate side communication tubes 330a and 330b are collectively referred to as a flow path plate side communication tube 330. The flow path plate side communication tube 330 protrudes from the flow path plate Su5 toward the case 335 and is inserted through the ink hole 322.

The case 335 includes case side communication tubes 336a and 336b. The case side communication tubes 336a and 336b are collectively referred to as a case side communication tube 336. The case side communication tube 336 protrudes from the case 335 toward the flow path plate Su5 and is inserted through the ink hole 322.

An adhesive forming a bonding portion GL57 is applied to a top surface of the flow path plate side communication tube 330 and a top surface of the case side communication tube 336.

A flow direction of ink in the in-head supply flow paths R1a and R1b is the Z2 direction. The top surface of the flow path plate side communication tube 330 and the top surface of the case side communication tube 336 are perpendicular to the flow direction of ink.

The description returns to FIGS. 5 and 6. As shown in FIG. 5, the fixing plate 36 is a plate member for fixing the plurality of head units Hn to the holder member 32. The fixing plate 36 includes a plurality of opening portions 361 for exposing the nozzles Nz of the plurality of head units Hn.

The reinforcing plate 37 is disposed between the holder member 32 and the fixing plate 36 and is fixed to the fixing plate 36 by an adhesive. The reinforcing plate 37 includes a plurality of opening portions 371 in which the plurality of head units Hn are disposed.

The wiring substrate 381 is a mounting component for electrically coupling the liquid ejecting head 30 to the control circuit 21 shown in FIG. 4. The wiring substrate 381 is disposed on the laminate 333. The wiring member 382 is installed on the wiring substrate 381. The wiring member 382 is a member for electrically coupling the liquid ejecting head 30 and the control circuit 21. The wiring member 382 is, for example, a connector. The wiring member 382 may be, for example, a signal cable such as a flexible flat cable (FFC).

The circuit boards 383u and 383v are disposed to sandwich the laminate 333 and are electrically coupled to the wiring substrate 381.

The flexible substrate 51 mounted on each of the head units H1 and H3 is electrically coupled to the circuit board 383u via a relay substrate (not shown). The flexible substrate 51 mounted on each of the head units H2 and H4 is electrically coupled to the circuit board 383v via a relay substrate (not shown).

### 1-6. Head Unit Hn

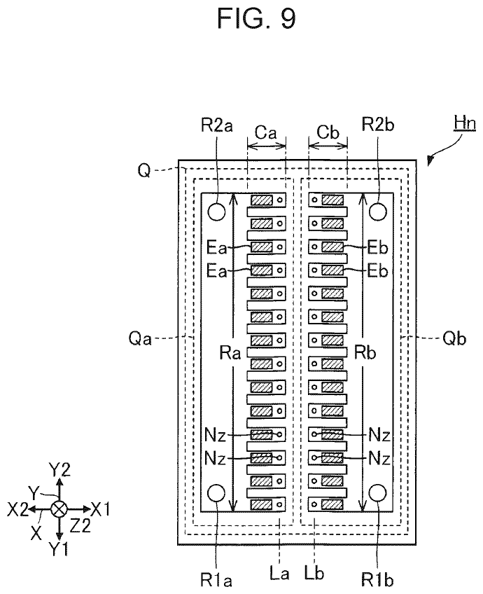

FIG. 8 is a cross-sectional view of the head unit Hn taken along the X-axis direction through the wiring hole 323. The view shown in FIG. 8 is a view of a cross-section of the head unit Hn taken along the X-axis direction through the wiring hole 323 as viewed in the Y2 direction. FIG. 9 is a plan view schematically showing the inside of the head unit Hn. The view shown in FIG. 9 is a plan view of the inside of the head unit Hn as viewed in the Z2 direction. In each of FIGS. 8 and 9, a portion of the head unit Hn shown in FIG. 6 in the vicinity of the fixing plate 36 is shown.

As shown in FIG. 8, the head unit Hn includes a nozzle plate 40, a communication plate 42, a pressure chamber substrate 43, a diaphragm 44, a plurality of drive elements E, a protection portion 46, a compliance substrate 45, and the case 335 mentioned above.

Each of the nozzle plate 40, the communication plate 42, the pressure chamber substrate 43, and the diaphragm 44 is an elongated plate-shaped member along the Y-axis. The pressure chamber substrate 43 and the case 335 are disposed in the Z1 direction with respect to the communication plate 42. On the other hand, the nozzle plate 40 and the compliance substrate 45 are disposed in the Z2 direction with respect to the communication plate 42. In addition, the members provided in the head unit Hn are joined to each other by an adhesive. Although not shown in FIG. 8, the layer formed by the adhesive joining the members provided in the head unit Hn to each other is also included in the bonding portion GL. The bonding portion GL liquid-tightly couples two members.

As shown in FIG. 9, the plurality of nozzles Nz are classified into a first nozzle row La and a second nozzle row Lb. Each of the first nozzle row La and the second nozzle row Lb is a group of a plurality of nozzles Nz arranged linearly along the Y-axis. The first nozzle row La and the second nozzle row Lb are spaced apart from each other and are arranged in the X-axis direction. Here, the liquid ejecting portion Q includes a first liquid ejecting portion Qa including a plurality of nozzles Nz belonging to the first nozzle row La, and a second liquid ejecting portion Qb including a plurality of nozzles Nz belonging to the second nozzle row Lb. The first liquid ejecting portion Qa ejects the first ink supplied from the sub tank 13a, from each nozzle Nz of the first nozzle row La. The second liquid ejecting portion Qb ejects the second ink supplied from the sub tank 13b, from each nozzle Nz of the second nozzle row Lb.

In the following description, a subscript “a” is added to reference numerals of elements related to the first nozzle row La, and a subscript “b” is added to reference numerals of elements related to the second nozzle row Lb. Additionally, elements related to the first liquid ejecting portion Qa and elements related to the second liquid ejecting portion Qb are disposed in a substantially plane-symmetrical structure. Accordingly, in the following description, elements corresponding to the first liquid ejecting portion Qa will be mainly described, and descriptions of elements corresponding to the second liquid ejecting portion Qb will be omitted as appropriate.

As shown in FIG. 8, the communication plate 42 is provided with the first communication flow path R3a and the second communication flow path R4a. Each of the first communication flow path R3a and the second communication flow path R4a is provided for each nozzle Nz. The nozzle Nz communicates with the pressure chamber Ca, which will be described below, through the first communication flow path R3a. The nozzle Nz communicates with the first liquid storage chamber Ra, which will be described below, through the second communication flow path R4a. Additionally, the compliance substrate 45 constitutes a part of a wall surface of the first liquid storage chamber Ra. The compliance substrate 45 includes, for example, a resin film 45a having flexibility and a metal plate 45b such as stainless steel.

The pressure chamber substrate 43 is provided with a plurality of pressure chambers Ca. The pressure chamber Ca is a space that communicates with the nozzle Nz via the first communication flow path R3a. The diaphragm 44 that is elastically deformable is disposed above the pressure chamber Ca. A part or all of the diaphragm 44 may be a separate member from the pressure chamber substrate 43 or may be integrated. In addition, a drive element Ea is formed for each pressure chamber Ca on a surface of the diaphragm 44 on a side opposite to the pressure chamber Ca. A plurality of drive elements Ea are disposed in one-to-one correspondence with the plurality of nozzles Nz. The drive element Ea generates energy for ejecting ink. Specifically, the drive element Ea ejects ink from the nozzle Nz by the application of the drive signal. For example, the drive element Ea is a piezoelectric element that changes the volume of the pressure chamber Ca.

The protection portion 46 is disposed above the diaphragm 44. Additionally, the flexible substrate 51 is joined to a surface of the diaphragm 44. A plurality of wirings for electrically coupling the control circuit 21 and the head unit Hn are formed at the flexible substrate 51. Further, a drive circuit 50 that drives the drive element E is mounted on the flexible substrate 51. The drive circuit 50 selects whether or not to supply various signals, such as a drive signal for driving each drive element Ea, to each drive element Ea based on signals output from the control circuit 21.

The case 335 includes the first liquid storage chamber Ra for storing ink. Additionally, the case 335 includes a part of the in-head supply flow paths R1a and R1b and the in-head discharge flow paths R2a and R2b mentioned above. As shown in FIG. 8, each of the in-head supply flow path R1a and the in-head discharge flow path R2a is coupled to the first liquid storage chamber Ra. Further, as shown in FIG. 8, the case 335 includes a substrate hole 411 through which the flexible substrate 51 is inserted.

### 1-7. Shape of In-Structure Flow Path Sn

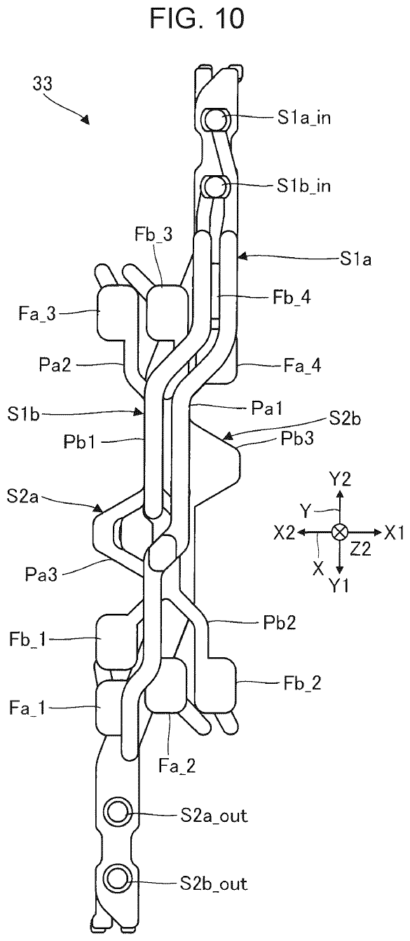

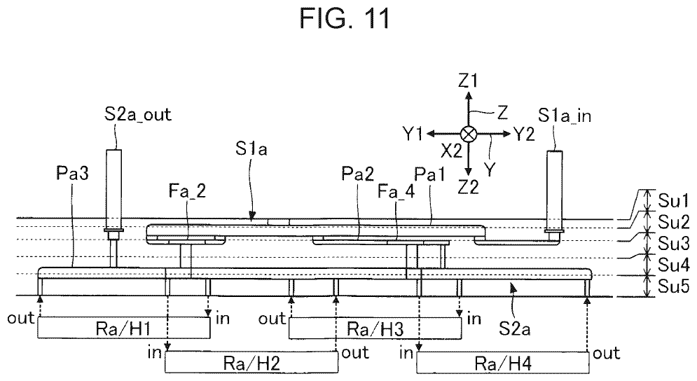

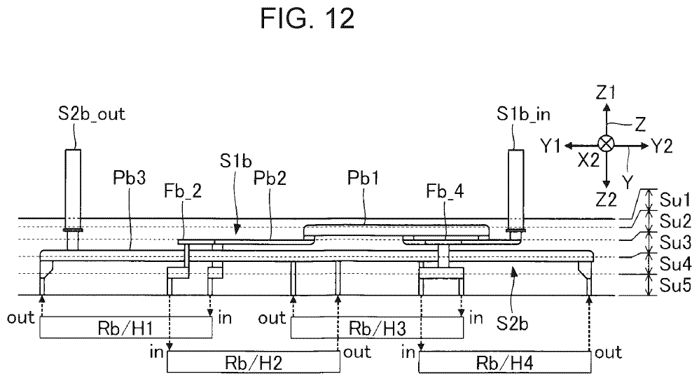

FIG. 10 is a plan view exemplifying the in-structure flow path Sn. FIG. 11 is a side view of the in-structure supply flow path S1a and the in-structure discharge flow path S2a of the in-structure flow path Sn, through which the first ink flows. FIG. 12 is a side view of the in-structure supply flow path S1b and the in-structure discharge flow path S2b of the in-structure flow path Sn, through which the second ink flows. In FIGS. 11 and 12, the first liquid storage chamber Ra of each head unit Hn is indicated by reference numeral “Ra/Hn”, and the second liquid storage chamber Rb of each head unit Hn is indicated by reference numeral “Rb/Hn”. The configuration of the in-structure flow path Sn is not limited to the following configuration.

As exemplified in FIGS. 10, 11, and 12, the flow path structure 33 is provided with the in-structure supply flow paths S1a and S1b and the in-structure discharge flow paths S2a and S2b. The in-structure supply flow path S1a is a flow path from the supply port Sla_in to the in-head supply flow path R1a of each head unit Hn, and the in-structure discharge flow path S2a is a flow path from the in-head discharge flow path R2a of each head unit Hn to the discharge port S2a out. The in-structure supply flow path S1b is a flow path from the supply port S1b in to the in-head supply flow path Rib of each head unit Hn, and the in-structure discharge flow path S2b is a flow path from the in-head discharge flow path R2b of each head unit Hn to the discharge port S2b out.

As exemplified in FIGS. 10 and 11, the in-structure supply flow path S1a is a flow path including a supply portion Pa1, a coupling portion Pa2, and four filter portions Fa_1 to Fa 4. As exemplified in FIG. 11, the supply portion Pa1 is formed between the flow path plates Su1 and Su2. The supply portion Pa1 has a shape extending along the Y-axis. An end portion of the supply portion Pa1 in the Y2 direction communicates with the supply port S1a in.

The in-structure supply flow path S1b is a flow path including a supply portion Pb1, a coupling portion Pb2, and four filter portions Fb_1 to Fb_4. The supply portion Pb1 is formed between the flow path plates Su1 and Su2. The supply portion Pb1 has a shape extending along the Y-axis. An end portion of the supply portion Pb1 in the Y2 direction communicates with the supply port S1b in.

The coupling portion Pa2 and the four filter portions Fa_1 to Fa 4 are formed between the flow path plates Su2 and Su3. The coupling portion Pa2 communicates with the supply portion Pa1 via a through-hole formed in the flow path plate Su2. The coupling portion Pa2 extends in the Y2 direction from a coupling position to the supply portion Pa1 and branches into two systems to communicate with the filter portions Fa_1 and Fa 3.

The filter portion Fa 2 communicates with the supply portion Pa1 via a through-hole formed in the flow path plate Su2. The filter portion Fa 4 communicates with the supply portion Pa1 via a through-hole formed in the flow path plate Su2. Each of the filter portions Fa_1 to Fa 4 communicates with the in-head supply flow path R1a of each head unit Hn via a through-hole penetrating through the flow path plates Su3 to Su5.

As exemplified in FIGS. 10 and 12, the in-structure supply flow path S1b is a flow path including a supply portion Pb1, a coupling portion Pb2, and four filter portions Fb_1 to Fb_4. The supply portion Pb1 is formed between the flow path plates Su1 and Su2. The supply portion Pb1 has a shape extending along the Y-axis. The supply port S1b in communicates with an end of the supply portion Pb1 in the Y2 direction. Here, the supply portions Pa1 and Pb1 are provided in parallel between the flow path plates Su1 and Su2.

The coupling portion Pb2 and the four filter portions Fb_1 to Fb_4 are formed between the flow path plates Su2 and Su3. The coupling portion Pb2 communicates with the supply portion Pb1 via a through-hole formed in the flow path plate Su2. The coupling portion Pb2 extends in the Y1 direction from a coupling position to the supply portion Pb1 and branches into two systems to communicate with the filter portions Fb_2 and Fb_4. Here, the coupling portion Pb2 extends in a direction opposite to the coupling portion Pa2 from the coupling position to the supply portion Pb1.

The filter portion Fb_1 communicates with the supply portion Pb1 via a through-hole formed in the flow path plate Su2. The filter portion Fb 3 communicates with the supply portion Pb1 via a through-hole formed in the flow path plate Su2. Each of the filter portions Fb_1 to Fb_4 communicates with the in-head supply flow path R1b of each head unit Hn via a through-hole penetrating through the flow path plates Su3 to Su5.

As exemplified in FIGS. 10 and 11, the in-structure discharge flow path S2a is a flow path including a discharge portion Pa3. The discharge portion Pa3 is formed between the flow path plates Su4 and Su5. The discharge portion Pa3 has a shape that extends along the Y-axis over a wider range than the supply portion Pa1. A vicinity of an end portion of the discharge portion Pa3 in the Y1 direction communicates with the discharge port S2a out. The in-head discharge flow path R2a of each head unit Hn communicates with the discharge portion Pa3 via a through-hole penetrating through the flow path plate Su5.

As exemplified in FIGS. 10 and 12, the in-structure discharge flow path S2b is a flow path including a discharge portion Pb3. The discharge portion Pb3 is formed between the flow path plates Su3 and Su4. The discharge portion Pb3 has a shape that extends along the Y-axis over a wider range than the supply portion Pb1. A vicinity of an end portion of the discharge portion Pb3 in the Y1 direction communicates with the discharge port S2b out. The in-head discharge flow path R2b of each head unit Hn communicates with the discharge portion Pb3 via a through-hole penetrating through the flow path plates Su4 and Su5.

### 1-8. Detection Mechanism 60 and Leakage Determination Circuit 29

In order to detect a sign of ink leakage from the flow path of the liquid ejecting head 30 to the outside, the detection mechanism 60 includes two conductive wires provided in both of the two flow path members. A set of two flow path members is two members constituting the liquid ejecting head 30 and need only be two members constituting a part of the flow path SF and bonded using some kind of adhesive. Specifically, the set of two flow path members is a set of two adjacent flow path plates Su in the flow path structure 33 and a set of the flow path plate Su5 and the case 335, and is a set of two members constituting the head unit Hn, constituting a part of the flow path SF, and bonded using some kind of adhesive. The set of two members in the head unit Hn is specifically a set of the case 335 and the communication plate 42, a set of the communication plate 42 and the pressure chamber substrate 43, a set of the communication plate 42 and the compliance substrate 45, a set of the communication plate 42 and the nozzle plate 40, and a set of the pressure chamber substrate 43 and the diaphragm 44.

FIGS. 13, 14, and 15 are views illustrating the detection mechanism 60. A location where the detection mechanism 60 is provided may be any of the sets of the two flow path members mentioned above, and may also be provided in a plurality of sets. However, the location where the detection mechanism 60 is provided may be any portion of the bonding portion GL, but it is preferable that the location is a location where the bonding portion GL is most likely to peel off, specifically, a location where an area of the bonding portion GL is smallest. FIGS. 13, 14, and 15 show an example in which the detection mechanism 60 is provided at a location bonded by the bonding portion GL57, that is, at a set of the flow path plate Su5 and the case 335.

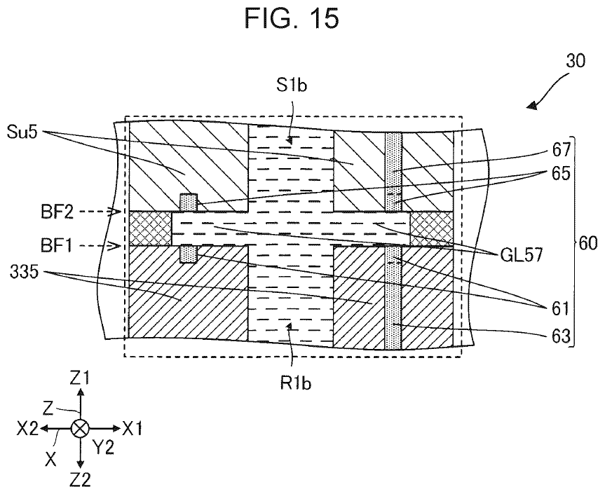

FIGS. 13 and 15 show the vicinity of the bonding portion GL57 shown in FIG. 5 in an enlarged manner. Additionally, FIG. 13 shows an initial state of the liquid ejecting head 30. In the present specification, the initial state of the liquid ejecting head 30 means a state after the liquid ejecting head 30 is manufactured and before the liquid ejecting head 30 is filled with ink. In addition, the initial state of the liquid ejecting head 30 can also be said to be a state in which the bonding portion GL is not in contact with ink. FIG. 15 shows a state in which a part of the bonding portion GL57 is deteriorated. As shown in FIG. 15, when the bonding portion GL57 deteriorates, and peels off or elutes into the flow path, ink penetrates into the bonding portion GL57. As shown in FIG. 13, the detection mechanism 60 includes a lower conductive wire 61, a lower wiring 63, an upper conductive wire 65, and an upper wiring 67. The lower conductive wire 61 is disposed at a first interface BF1 between the case 335 and the bonding portion GL57. The upper conductive wire 65 is disposed at a second interface BF2 between the flow path plate Su5 and the bonding portion GL57. The lower wiring 63 functions as a lead-out wire of the lower conductive wire 61. The lower wiring 63 penetrates through the case 335 in the direction along the Z-axis, and one end of the lower wiring 63 is coupled to one end of the lower conductive wire 61 in the X1 direction. The other end of the lower wiring 63 is coupled to the flexible substrate 51, although not shown. The lower conductive wire 61 is coupled to the leakage determination circuit 29 via the lower wiring 63, the flexible substrate 51, the circuit board 383u or 383v, and the wiring substrate 381. The upper wiring 67 functions as a lead-out wire of the upper conductive wire 65. The upper wiring 67 penetrates through the flow path plate Su5 in the direction along the Z-axis, and one end of the upper wiring 67 is coupled to one end of the upper conductive wire 65 in the X1 direction. The other end of the upper wiring 67 is coupled to the circuit board 383v, although not shown. Similarly to the lower conductive wire 61, the upper conductive wire 65 is coupled to the leakage determination circuit 29 via the upper wiring 67, the circuit board 383v, and the wiring substrate 381.

In the examples of FIGS. 13, 14, and 15, the case 335 corresponds to a “first flow path member”, the flow path plate Su5 corresponds to a “second flow path member”, and the bonding portion GL57 corresponds to a “bonding portion”. The in-head supply flow path Rib corresponds to a “first flow path”, and the in-structure supply flow path S1b corresponds to a “second flow path”. The first interface BF1 corresponds to a “first interface”, and the lower conductive wire 61 corresponds to a “first conductive wire”. Additionally, the second interface BF2 corresponds to a “second interface”, and the upper conductive wire 65 corresponds to a “third conductive wire”.

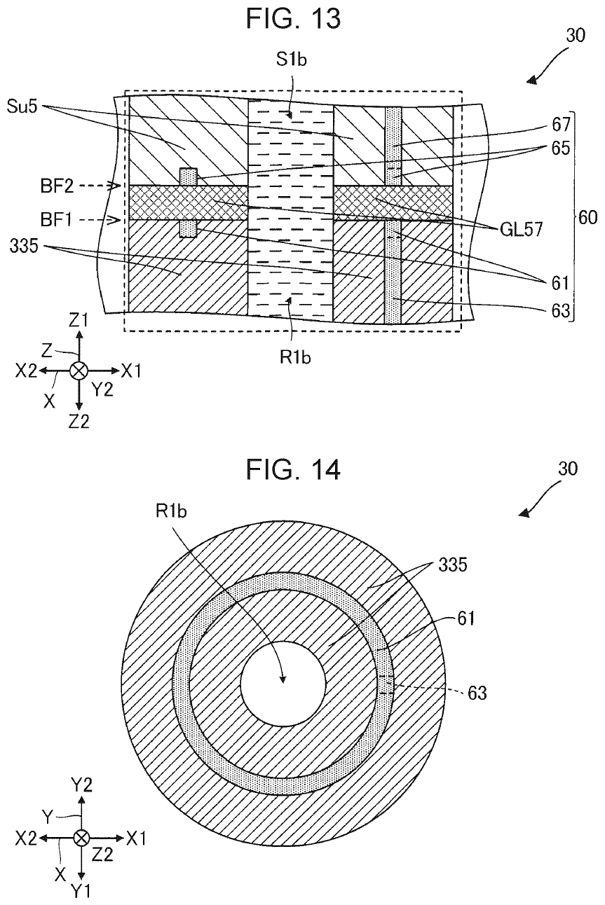

FIG. 14 shows a state in which the first interface BF1 is viewed in the Z2 direction. As shown in FIG. 14, the lower conductive wire 61 has an annular shape. The lower conductive wire 61 is provided so as to be spaced apart from and extend along the in-head supply flow path R1b. The extent to which the lower conductive wire 61 is spaced apart from the in-head supply flow path Rib is not particularly limited, but is, for example, half of a distance from the in-head supply flow path R1b to the lower wiring 63. In addition, in the example shown in FIG. 14, a contour of the lower conductive wire 61 is a circular shape that is concentric with a contour of the in-head supply flow path R1b, but the present disclosure is not limited thereto. For example, the contour of the lower conductive wire 61 may be an elliptical shape or a rectangular shape.

Although not shown in FIG. 14, the upper conductive wire 65 has an annular shape. The upper conductive wire 65 is provided so as to be spaced apart from and extend along the in-structure supply flow path S1b. In the example shown in FIG. 14, a contour of the upper conductive wire 65 is a circular shape that is concentric with a contour of the in-structure supply flow path S1b, but the present disclosure is not limited thereto. For example, the contour of the upper conductive wire 65 may be an elliptical shape or a rectangular shape.

In plan view, it is preferable that the lower conductive wire 61 and the upper conductive wire 65 overlap each other, but the lower conductive wire 61 and the upper conductive wire 65 need not overlap each other. In the following description, it is assumed that the lower conductive wire 61 and the upper conductive wire 65 overlap each other.

A method of detecting ink leakage will be described with reference to FIGS. 13 and 15. A first aspect in which ink has conductive properties and the bonding portion GL57 has insulating properties, and a second aspect in which ink has insulating properties and the bonding portion GL57 has conductive properties will be described. Hereinafter, the first aspect may be referred to as “first aspect relating to conductive properties”, and the second aspect may be referred to as “second aspect relating to conductive properties”.

### 1-8-1. First Aspect Relating to Conductive Properties

In the first aspect relating to conductive properties, in the initial state of the liquid ejecting head 30 as shown in FIG. 13, since the bonding portion GL57 having insulating properties is present between the lower conductive wire 61 and the upper conductive wire 65, the lower conductive wire 61 and the upper conductive wire 65 are in a non-conductive state. On the other hand, as shown in FIG. 15, when the bonding portion GL57 deteriorates and ink penetrates into the bonding portion GL57, the lower conductive wire 61 and the upper conductive wire 65 are electrically coupled via the ink having conductive properties. Therefore, the lower conductive wire 61 and the upper conductive wire 65 are in a conductive state.

The ink having conductive properties is, for example, an aqueous ink containing an electrolyte. However, the ink having conductive properties is not limited to the aqueous ink having an electrolyte and may be UV ink having an electrolyte. The bonding portion GL having insulating properties is formed by, for example, an adhesive having insulating properties.

The bonding portion GL having insulating properties is, for example, an adhesive such as an epoxy-based adhesive, a phenol-based adhesive, an acrylic-based adhesive, and a urethane-based adhesive.

The leakage determination circuit 29 determines, as the leakage determination process, whether or not there is a sign of ink leakage from the liquid ejecting head 30 based on a magnitude of a current between the lower conductive wire 61 and the upper conductive wire 65 with respect to the detection mechanism 60. It can be said that determining whether or not there is a sign of ink leakage is to determine whether or not ink penetrates into the bonding portion GL57, and also to determine whether or not the bonding strength of the bonding portion GL57 is decreased.

As a specific process of the leakage determination circuit 29, the leakage determination circuit 29 determines whether or not there is a sign of ink leakage from the liquid ejecting head 30, based on whether or not the current between the lower conductive wire 61 and the upper conductive wire 65 is zero, in other words, based on whether the lower conductive wire 61 and the upper conductive wire 65 are in a conductive state or a non-conductive state. For example, when the lower conductive wire 61 and the upper conductive wire 65 are in a non-conductive state, the leakage determination circuit 29 generates information indicating that there is no sign of ink leakage. On the other hand, when the lower conductive wire 61 and the upper conductive wire 65 are in a conductive state, the leakage determination circuit 29 generates information indicating that there is a sign of ink leakage. The leakage determination circuit 29 transmits the information indicating whether or not there is a sign of ink leakage to the control circuit 21 as the determination information JI.

### 1-8-2. Second Aspect Relating to Conductive Properties

In the second aspect relating to conductive properties, in the initial state of the liquid ejecting head 30 as shown in FIG. 13, since the bonding portion GL57 having conductive properties is present between the lower conductive wire 61 and the upper conductive wire 65, the lower conductive wire 61 and the upper conductive wire 65 are in a conductive state. On the other hand, when the bonding portion GL57 as shown in FIG. 15 deteriorates and ink penetrates into the bonding portion GL57, a space between the lower conductive wire 61 and the upper conductive wire 65 is blocked by ink having insulating properties. Therefore, the lower conductive wire 61 and the upper conductive wire 65 are in a non-conductive state.

The ink having insulating properties is, for example, UV ink, but the present disclosure is not limited thereto. For example, ink having insulating properties may be an aqueous ink having no electrolyte. The bonding portion GL having conductive properties is formed of, for example, an epoxy-based adhesive, a phenol-based adhesive, an acrylic-based adhesive, a urethane-based adhesive, or the like, which contains conductive particles such as gold, silver, copper, nickel, or carbon.

The leakage determination circuit 29 determines whether the lower conductive wire 61 and the upper conductive wire 65 are in a conductive state or a non-conductive state as the leakage determination process. For example, when the lower conductive wire 61 and the upper conductive wire 65 are in a conductive state, the leakage determination circuit 29 generates information indicating that there is no sign of ink leakage. On the other hand, when the lower conductive wire 61 and the upper conductive wire 65 are in a non-conductive state, the leakage determination circuit 29 generates information indicating that there is a sign of ink leakage. The leakage determination circuit 29 transmits the information indicating whether or not there is a sign of ink leakage to the control circuit 21 as the determination information JI.

### 1-8-3. Summary of Detection Mechanism 60 and Leakage Determination Circuit 29

As understood from the above-mentioned description, in any of the first aspect relating to conductive properties and the second aspect relating to conductive properties, the conductive state and the non-conductive state between the lower conductive wire 61 and the upper conductive wire 65 are switched depending on whether or not the bonding portion GL57 deteriorates and ink penetrates into the bonding portion GL57. Additionally, as understood from the above-mentioned description, in any of the first aspect relating to conductive properties and the second aspect relating to conductive properties, the leakage determination circuit 29 determines whether the two wirings in the detection mechanism 60, that is, the lower conductive wire 61 and the upper conductive wire 65, are in a conductive state or a non-conductive state. The leakage determination circuit 29 includes a known circuit capable of determining whether the conductive wires are in a conductive state or a non-conductive state using a power supply potential VHV.

### 1-9. Functions of First Embodiment

The detection mechanism 60 and the leakage determination circuit 29 can detect the presence or absence of a sign of ink leakage from the liquid ejecting head 30. In addition, it is preferable to replace the liquid ejecting head 30 before ink leaks from the liquid ejecting head 30. Accordingly, in the ink jet system SYS according to the present embodiment, when it is determined that there is a sign of ink leakage from the liquid ejecting head 30, a function of prompting the user U to replace the liquid ejecting head 30 is provided.

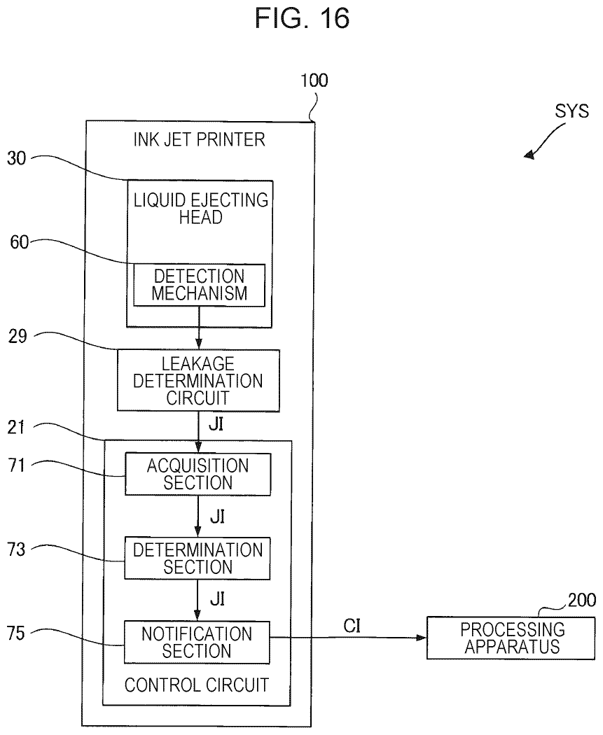

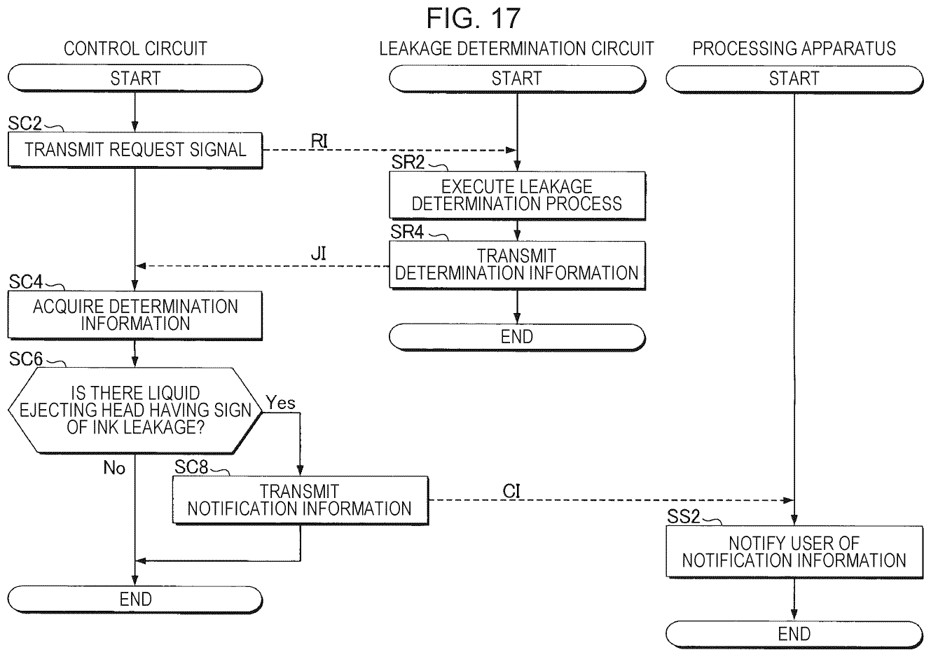

FIG. 16 is a diagram showing a function of the ink jet system SYS. FIG. 17 is a flowchart showing an operation of the ink jet system SYS. The control circuit 21 functions as an acquisition section 71, a determination section 73, and a notification section 75 by executing the read control program PM2.

A series of processes shown in FIG. 17 are periodically executed. For example, the ink jet system SYS executes the series of processes shown in FIG. 17 every day, every week, or every month. However, the series of processes shown in FIG. 17 may be executed irregularly. For example, when the ink jet system SYS receives the image data Img from the processing apparatus 200, the ink jet system SYS may execute the series of processes shown in FIG. 17 before the printing process, or may execute the series of processes shown in FIG. 17 in response to an instruction from the user U.

In step SC2, the control circuit 21 transmits the request signal RI to the leakage determination circuit 29. After the end of processing in step SC2, the control circuit 21 waits for a response from the leakage determination circuit 29.

When the leakage determination circuit 29 receives the request signal RI, the leakage determination circuit 29 executes the leakage determination process in step SR2. After the end of processing in step SR2, the leakage determination circuit 29 transmits the determination information JI indicating the determination result to the control circuit 21 in step SR4. After the end of processing in step SR4, the leakage determination circuit 29 ends the series of processes shown in FIG. 17.

The control circuit 21 functions as the acquisition section 71 to acquire the determination information JI from the leakage determination circuit 29 in step SC4. Next, the control circuit 21 functions as the determination section 73 to determine whether or not there is the liquid ejecting head 30 having a sign of ink leakage by referring to the determination information JI, in step SC6.

When the determination result in step SC6 is affirmative, the control circuit 21 functions as the notification section 75 to generate notification information CI based on the determination information JI and to notify the user U of the generated notification information CI, in step SC8. The notification information CI is information regarding the liquid ejecting head 30 having a sign of ink leakage. The notification information CI is, for example, a character string regarding the liquid ejecting head 30 having a sign of ink leakage. For example, it is assumed that the determination information JI indicates that there is a sign of ink leakage in the liquid ejecting head 30. On this assumption, the notification information CI is a character string stating “There is a sign that the liquid ejecting head is failing. Specifically, there is a sign of ink leakage from this liquid ejecting head”. The notification information CI may include a character string indicating replacement of the liquid ejecting head 30. The character string indicating replacement of the liquid ejecting head 30 is a character string stating “Please replace the liquid ejecting head” or a character string stating “It is recommended to replace the liquid ejecting head”. In addition, the notification information CI is not limited to the character string. For example, the notification information CI may be information indicating an image in which a highlighted image that highlights the liquid ejecting head 30 having a sign of ink leakage is superimposed on an image indicating the head module 3. The highlighted image is, for example, an image in which a color of the liquid ejecting head 30 having a sign of ink leakage is made different from a color of the liquid ejecting head 30 having no sign of ink leakage, or an image in which a balloon pointing to the liquid ejecting head 30 having a sign of ink leakage is provided, the balloon including a character string stating “It is recommended to replace this liquid ejecting head”.

After the end of processing in step SC8, the control circuit 21 ends the series of processes shown in FIG. 17. Additionally, when the determination result in step SC6 is negative, the control circuit 21 also ends the series of processes shown in FIG. 17.

When the processing apparatus 200 receives the notification information CI, the control circuit 210 of the processing apparatus 200 notifies the user U of the notification information CI in step SS2. Specifically, the control circuit 210 displays the character string or the image indicated by the notification information CI on the display device 270.

In FIGS. 16 and 17, the control circuit 21 functions as the determination section 73 and the notification section 75, but the present disclosure is not limited thereto. For example, the control circuit 21 may transmit the determination information JI to the processing apparatus 200, and the control circuit 210 of the processing apparatus 200 may function as the determination section 73 and the notification section 75.

### 1-10. Summary of First Embodiment

As described above, the liquid ejecting head 30 in the first embodiment includes the case 335, the flow path plate Su5, the bonding portion GL57, the lower conductive wire 61, and the upper conductive wire 65. The case 335 constitutes the in-head supply flow path R1b communicating with the nozzle Nz that ejects ink. The flow path plate Su5 constitutes the in-structure supply flow path S1b communicating with the in-head supply flow path R1b.

The bonding portion GL57 bonds the case 335 and the flow path plate Su5 such that the in-head supply flow path R1b and the in-structure supply flow path Sb are in liquid-tight communication. The lower conductive wire 61 is disposed at the first interface BF1 between the case 335 and the bonding portion GL57 so as to be spaced apart from the in-head supply flow path R1b. The upper conductive wire 65 is disposed at the second interface BF2 between the flow path plate Su5 and the bonding portion GL57 so as to be spaced apart from the in-structure supply flow path S1b.

According to the first embodiment, it is possible to detect a sign of ink leakage from the liquid ejecting head 30 by using that the conductive state and the non-conductive state between the lower conductive wire 61 and the upper conductive wire 65 are switched depending on whether or not the bonding portion GL57 deteriorates and ink penetrates into the bonding portion GL57. The user U can know a time point at which a sign of ink leakage from the liquid ejecting head 30 is detected as an appropriate timing for replacing the liquid ejecting head 30. In addition, according to the present embodiment, it is possible to detect a sign of ink leakage from the liquid ejecting head 30 without destroying the liquid ejecting head 30.

In the first aspect relating to conductive properties, the ink ejected from the nozzle Nz has conductive properties, and the bonding portion GL57 has insulating properties. Additionally, in the second aspect relating to conductive properties, the ink ejected from the nozzle Nz has insulating properties, and the bonding portion GL57 has conductive properties.

According to the first aspect relating to conductive properties, the present disclosure can be applied to ink having conductive properties such as an aqueous ink. In addition, according to the second aspect relating to conductive properties, the present disclosure can be applied to ink having insulating properties such as UV ink. Further, by containing conductive particles in the bonding portion GL57, the bonding portion GL57 can have conductive properties, but the bonding strength decreases. Therefore, according to the first aspect relating to conductive properties, as compared with the second aspect relating to conductive properties, since conductive particles need not be contained in the bonding portion GL57, the bonding strength does not decrease, whereby the bonding portion GL57 can be applied thinly.

### 2. Second Embodiment and Third Embodiment

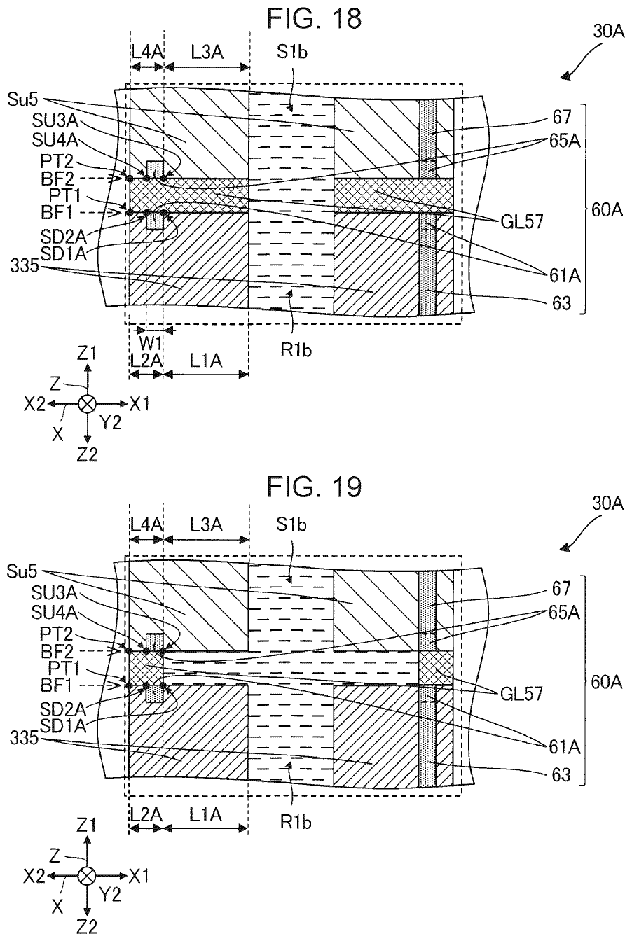

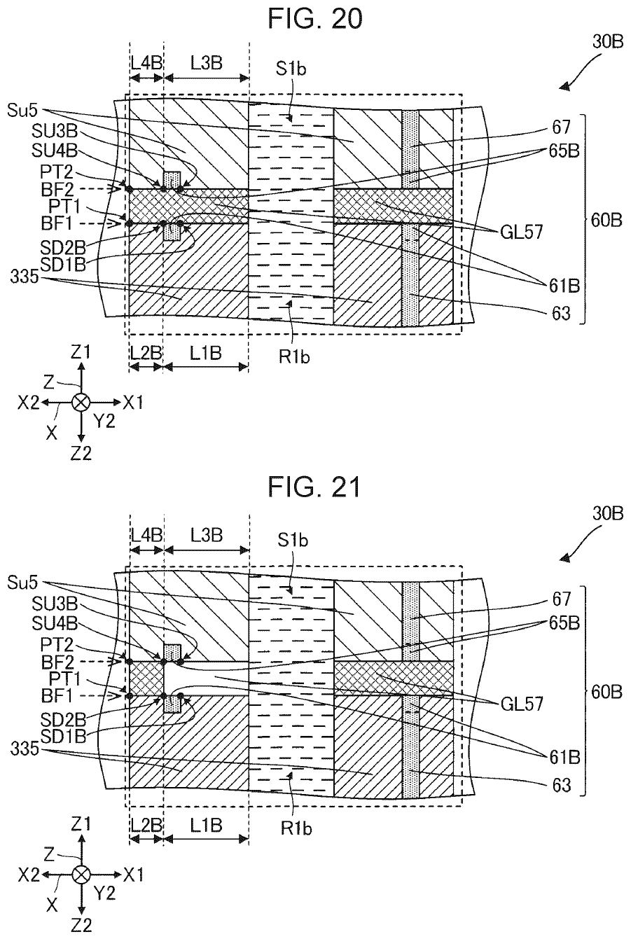

In the first embodiment, it is possible to detect that there is a sign of ink leakage from the liquid ejecting head 30, but detection is limited to merely detecting that there is a sign of ink leakage. Accordingly, in a second embodiment, in the first aspect relating to conductive properties, it is possible to detect that ink will soon leak from the liquid ejecting head 30, and in a third embodiment, in the second aspect relating to conductive properties, it is possible to detect that ink will soon leak from the liquid ejecting head 30. Hereinafter, the second embodiment will be described with reference to FIGS. 18 and 19, and the third embodiment will be described with reference to FIGS. 20 and 21.

FIGS. 18 and 19 are views illustrating a detection mechanism 60A in the second embodiment. A liquid ejecting head 30A in the second embodiment includes the detection mechanism 60A instead of the detection mechanism 60. The detection mechanism 60A includes a lower conductive wire 61A instead of the lower conductive wire 61, and includes an upper conductive wire 65A instead of the upper conductive wire 65. FIG. 18 shows a state immediately after the liquid ejecting head 30A is filled with ink from the initial state of the liquid ejecting head 30A. FIG. 19 shows a state in which a part of the bonding portion GL57 is deteriorated in the liquid ejecting head 30A.

The lower conductive wire 61A includes two sides, that is, a first side SD1A and a second side SD2A, along an extending direction of the lower conductive wire 61A. The extending direction of the lower conductive wire 61A corresponds to a circumferential direction along the contour of the lower conductive wire 61A when the contour of the lower conductive wire 61A is the same annular shape as the lower conductive wire 61 shown in FIG. 14 of the first embodiment. When the lower conductive wire 61A includes a portion extending linearly along a certain imaginary straight line, the extending direction of the lower conductive wire 61A in the portion corresponds to an extending direction of the imaginary straight line. Similarly, the upper conductive wire 65A includes two sides, that is, a third side SU3A and a fourth side SU4A, along an extending direction of the upper conductive wire 65A. The extending direction of the upper conductive wire 65A need only be defined by the same method as the extending direction of the lower conductive wire 61A. As understood from FIGS. 18 and 19, the first side SD1A is disposed closer to the in-head supply flow path Rib than the second side SD2A. Similarly, the third side SU3A is disposed closer to the in-structure supply flow path S1b than the fourth side SU4A. As understood from FIG. 19, in the first aspect relating to conductive properties, a timing at which the conductive state and the non-conductive state between the lower conductive wire 61A and the upper conductive wire 65A are switched is when ink comes into contact with both the first side SD1A and the third side SU3A. Accordingly, in order to enable detection that ink will soon leak from the liquid ejecting head 30A, in the second embodiment, a shortest distance L1A from the first side SD1A to the in-head supply flow path Rib is set longer than a shortest distance L2A from the first side SD1A to a first end PT1 of the first interface BF1. The first end PT1 is disposed on a side opposite to the in-head supply flow path R1b with the lower conductive wire 61A interposed between the first end PT1 and the in-head supply flow path R1b. The shorter the shortest distance L2A is, the closer to a time point, that is, a timing at which ink leaks from the liquid ejecting head 30A, a sign of ink leakage can be detected. However, when a length obtained by subtracting a width W1 of the lower conductive wire 61A from the shortest distance L2A, in other words, a length from the second side SD2A to the first end PT1, is too short, an area of the first interface BF1 from the second side SD2A to the first end PT1 becomes narrow, which may cause ink to easily leak to the outside. For example, the length obtained by subtracting the width W1 of the lower conductive wire 61A from the shortest distance L2A is preferably longer than zero, and more preferably 10% or greater of the sum of the shortest distance L1A and the shortest distance L2A. The width W1 is the width of the lower conductive wire 61A orthogonal to the extending direction of the lower conductive wire 61A and is a length from the first side SD1A to the second side SD2A in plan view. The sum of the shortest distance L1A and the shortest distance L2A coincides with a width of the bonding portion GL57. In the second embodiment, a shortest distance L3A from the third side SU3A to the in-structure supply flow path S1b substantially coincides with the shortest distance L1A, and a shortest distance L4A from the third side SU3A to a second end PT2 of the second interface BF2 substantially coincides with the shortest distance L2A.

The first side SD1A corresponds to a “first side”, the first end PT1 corresponds to a “first end”, the shortest distance L1A corresponds to a “shortest distance from the first side to the first flow path”, the shortest distance L2A corresponds to a “shortest distance from the first side to the first end”, and the width W1 corresponds to a “width of the first conductive wire”.

The notification section 75 in the second embodiment may notify the user U of the information indicating that there is a sign of ink leakage from the liquid ejecting head 30A and lifetime information indicating a lifetime of the liquid ejecting head 30A, as the notification information CI. The lifetime information is, for example, a character string stating “The expected failure date of the liquid ejecting head 30 is yyyy/mm/dd”. yyyy is a four-digit numerical value. mm is an integer from 1 to 12. dd is an integer from 1 to 31. In order to generate the lifetime information, the storage circuit 22 in the second embodiment stores information indicating a date of start of use of the liquid ejecting head 30A, information indicating the shortest distance L1A, and information indicating the shortest distance L2A. It is assumed that the notification information CI indicates that there is a sign of ink leakage in the liquid ejecting head 30A. The notification section 75 calculates the lifetime of the liquid ejecting head 30A by using the following Equation (1).

Lifetime of the liquid ejecting head 30A=(Current date−Date of start of use of the liquid ejecting head 30A)×(Shortest distance L1A+Shortest distance L2A)/Shortest distance L2A+Current date (1)

When the lifetime information is generated, the notification section 75 may notify the user U of the notification information CI immediately after the lifetime information is generated or may notify the user U of the notification information CI a predetermined number of days before the date indicated by the lifetime information.

As described above, according to the second embodiment, the lower conductive wire 61A includes the first side SD1A and the second side SD2A along the extending direction of the lower conductive wire 61A, the first side SD1A is disposed at a position closer to the in-head supply flow path Rib than the second side SD2A, the first interface BF1 includes the first end PT1 that is disposed on the side opposite to the in-head supply flow path Rib with the lower conductive wire 61A interposed between the first end PT1 and the in-head supply flow path R1b, and the shortest distance L1A from the first side SD1A of the two sides that is closer to the in-head supply flow path R1b to the in-head supply flow path Rib is longer than the shortest distance L2A from the first side SD1A to the first end PT1.

According to the second embodiment, in the first aspect relating to conductive properties, as compared with an aspect in which the shortest distance L1A is shorter than the shortest distance L2A, it is possible to detect a sign of ink leakage from the liquid ejecting head 30A at a timing closer to a time point at which ink leaks from the liquid ejecting head 30A. Therefore, in the second embodiment, when the liquid ejecting head 30A is replaced at a time point at which a sign of ink leakage from the liquid ejecting head 30A is detected, it is possible to extend a usage period of the liquid ejecting head 30A as compared with an aspect in which the shortest distance L1A is shorter than the shortest distance L2A.

Additionally, the length obtained by subtracting the width of the lower conductive wire 61A from the shortest distance L2A from the first side SD1A to the first end PT1 is longer than zero.

According to the second embodiment, since the shortest distance L2A is longer than zero, it is possible to detect that ink will soon leak from the liquid ejecting head 30A.

FIGS. 20 and 21 are views illustrating a detection mechanism 60B in the third embodiment. A liquid ejecting head 30B in the third embodiment includes a detection mechanism 60B instead of the detection mechanism 60. The detection mechanism 60B includes a lower conductive wire 61B instead of the lower conductive wire 61, and includes an upper conductive wire 65B instead of the upper conductive wire 65. FIG. 20 shows a state immediately after the liquid ejecting head 30B is filled with ink from the initial state of the liquid ejecting head 30B. FIG. 21 shows a state in which a part of the bonding portion GL57 is deteriorated in the liquid ejecting head 30B.

The lower conductive wire 61B includes two sides, that is, a first side SD1B and a second side SD2B, along an extending direction of the lower conductive wire 61B. Similarly, the upper conductive wire 65B includes two sides, that is, a third side SU3B and a fourth side SU4B, along an extending direction of the upper conductive wire 65B. As understood from FIGS. 20 and 21, the first side SD1B is disposed closer to the in-head supply flow path R1b than the second side SD2B. Similarly, the third side SU3B is disposed closer to the in-structure supply flow path S1b than the fourth side SU4B. As understood from FIG. 21, in the second aspect relating to conductive properties, a timing at which the conductive state and the non-conductive state between the lower conductive wire 61B and the upper conductive wire 65B are switched is when ink comes into contact with both the second side SD2B and the fourth side SU4B. Accordingly, in order to enable detection that ink will soon leak from the liquid ejecting head 30B, in the third embodiment, a shortest distance L1B from the second side SD2B to the in-head supply flow path Rib is set longer than a shortest distance L2B from the second side SD2B to the first end PT1. Similarly to the shortest distance L2A, the shorter the shortest distance L2B is, the closer to a time point, that is, a timing at which ink leaks from the liquid ejecting head 30B, a sign of ink leakage can be detected. Therefore, the shortest distance L2B is longer than zero. However, when the shortest distance L2B is too short, the area of the first interface BF1 from the first end PT1 to the second side SD2B becomes narrow, which may cause ink to easily leak. For example, the shortest distance L2B is preferably 10% or greater of the sum of the shortest distance L1B and the shortest distance L2B. The sum of the shortest distance L1B and the shortest distance L2B coincides with the width of the bonding portion GL57. In addition, in the third embodiment, a shortest distance L3B from the fourth side SU4B to the in-structure supply flow path S1b substantially coincides with the shortest distance L1B, and a shortest distance L4B from the fourth side SU4B to the second end PT2 substantially coincides with the shortest distance L2B.

The first side SD1B corresponds to a “first side”, the first end PT1 corresponds to a “first end”, the shortest distance L1B corresponds to a “shortest distance from the second side to the first flow path”, and the shortest distance L2B corresponds to a “shortest distance from the second side to the first end”.

Similarly to the second embodiment, the notification section 75 in the third embodiment may notify the user U of information indicating that there is a sign of ink leakage from the liquid ejecting head 30B and lifetime information indicating a lifetime of the liquid ejecting head 30B, as the notification information CI. In order to generate the lifetime information, the storage circuit 22 in the third embodiment stores information indicating a date of start of use of the liquid ejecting head 30B, information indicating the shortest distance LIB, and information indicating the shortest distance L2B. It is assumed that the notification information CI indicates that there is a sign of ink leakage in the liquid ejecting head 30B. The notification section 75 calculates the lifetime of the liquid ejecting head 30B by using the following Equation (2).

Lifetime of the liquid ejecting head 30B=(Current date−Date of start of use of the liquid ejecting head 30B)×(Shortest distance L1B+Shortest distance L2B)/Shortest distance L2B+Current date (2)

Similarly to the second embodiment, when the lifetime information is generated, the notification section 75 in the third embodiment may notify the user U of the notification information CI immediately after the lifetime information is generated or may notify the user U of the notification information CI a predetermined number of days before the date indicated by the lifetime information.

As described above, according to the third embodiment, the lower conductive wire 61B includes the first side SD1B and the second side SD2B along the extending direction of the lower conductive wire 61B, the first side SD1B is disposed at a position closer to the in-head supply flow path Rib than the second side SD2B, the first interface BF1 includes the first end PT1 that is disposed on the side opposite to the in-head supply flow path Rib with the lower conductive wire 61B interposed between the first end PT1 and the in-head supply flow path R1b, and the shortest distance L1B from the second side SD2B to the in-head supply flow path Rib is longer than the shortest distance L2B from the second side SD2B to the first end PT1.

According to the third embodiment, in the second aspect relating to conductive properties, as compared with an aspect in which the shortest distance LIB is shorter than the shortest distance L2B, it is possible to detect a sign of ink leakage from the liquid ejecting head 30B at a timing closer to a time point at which ink leaks from the liquid ejecting head 30B. Therefore, according to the third embodiment, when the liquid ejecting head 30B is replaced at a time point at which a sign of ink leakage from the liquid ejecting head 30B is detected, it is possible to extend the usage period of the liquid ejecting head 30B as compared with an aspect in which the shortest distance LIB is shorter than the shortest distance L2B.

Additionally, the shortest distance L2B from the second side SD2B to the first end PT1 is longer than zero.

Since the shortest distance L2B is longer than zero, it is possible to detect that ink will soon leak from the liquid ejecting head 30B.

### 3. Fourth Embodiment

In a fourth embodiment, a sign of ink leakage from the liquid ejecting head 30 can be detected in multiple stages.

### 3-1. Operation of Fourth Embodiment

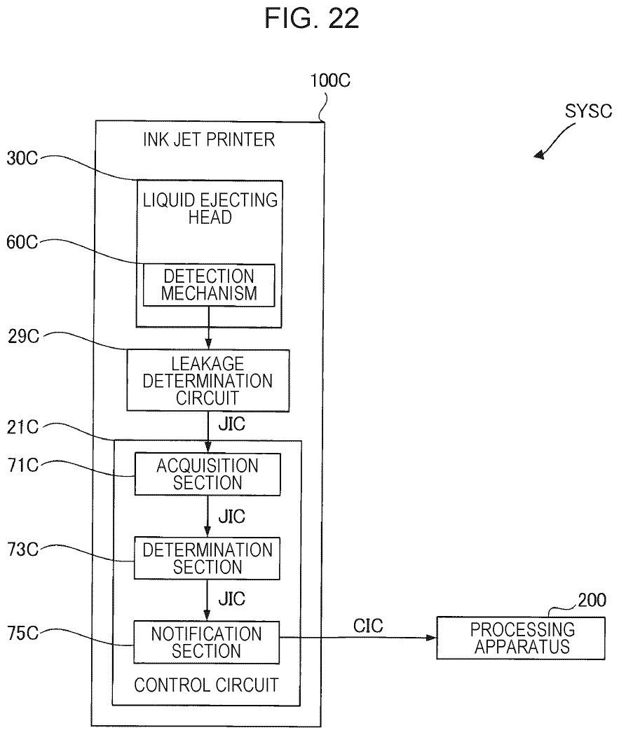

FIG. 22 is a diagram showing a function of an ink jet system SYSC in the fourth embodiment. The ink jet system SYSC includes an ink jet printer 100C instead of the ink jet printer 100. The ink jet printer 100C includes a liquid ejecting head 30C instead of the liquid ejecting head 30, includes a leakage determination circuit 29C instead of the leakage determination circuit 29, and includes a control circuit 21C instead of the control circuit 21. The liquid ejecting head 30C includes a detection mechanism 60C instead of the detection mechanism 60.

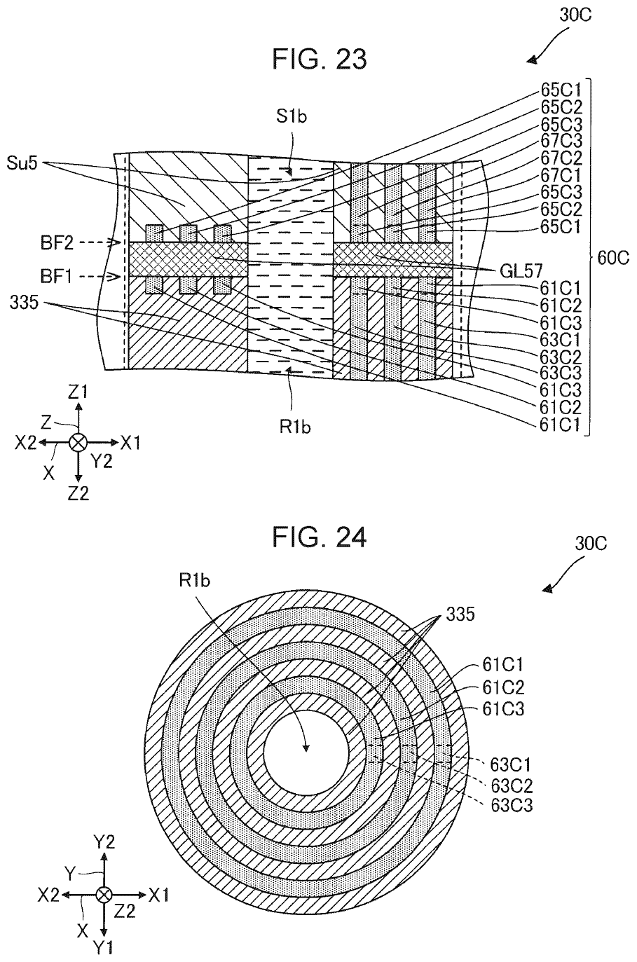

FIGS. 23 and 24 are views illustrating the detection mechanism 60C in the fourth embodiment. FIG. 23 shows the vicinity of the bonding portion GL57 of the liquid ejecting head 30C in an enlarged manner. FIG. 24 shows a state in which the first interface BF1 is viewed in the Z2 direction.

The detection mechanism 60C includes lower conductive wires 61C1, 61C2, and 61C3 disposed at the first interface BF1, lower wirings 63C1, 63C2, and 63C3, and upper conductive wires 65C1, 65C2, and 65C3 disposed at the second interface BF2, and upper wirings 67C1, 67C2, and 67C3. As understood from FIGS. 23 and 24, in the fourth embodiment, a sign of ink leakage from the liquid ejecting head 30C can be detected in three stages.

The lower wirings 63C1 to 63C3 function as lead-out wires of the lower conductive wires 61C1 to 61C3, respectively. The lower wirings 63C1 to 63C3 penetrate through the case 335 in the direction along the Z-axis. The upper wirings 67C1 to 67C3 function as lead-out wires of the upper conductive wires 65C1 to 65C3, respectively. The upper wirings 67C1 to 67C3 penetrate through the flow path plate Su5 in the direction along the Z-axis.

As understood from FIG. 23, the lower conductive wire 61C3 is disposed outside the in-head supply flow path R1b. The lower conductive wire 61C2 is disposed outside the lower conductive wire 61C3. The lower conductive wire 61C1 is disposed outside the lower conductive wire 61C2. In other words, the lower conductive wire 61C2 and the lower conductive wire 61C3 are disposed between the lower conductive wire 61C1 and the in-head supply flow path R1b. Similarly, the upper conductive wire 65C3 is disposed outside the in-structure supply flow path S1b. The upper conductive wire 65C2 is disposed outside the upper conductive wire 65C3. The upper conductive wire 65C1 is disposed outside the upper conductive wire 65C2. In other words, the upper conductive wire 65C2 and the upper conductive wire 65C3 are disposed between the upper conductive wire 65C1 and the in-structure supply flow path S1b. In the fourth embodiment, the lower conductive wire 61C1 is an example of a “first conductive wire”, and the lower conductive wire 61C2 and the lower conductive wire 61C3 are examples of a “second conductive wire”.

The description returns to FIG. 22. The leakage determination circuit 29C outputs determination information JIC instead of the determination information JI. The leakage determination circuit 29C transmits information indicating the degree of a sign of ink leakage to the control circuit 21C, as the determination information JIC. The information indicating the degree of a sign of ink leakage includes, for example, no-sign information indicating that there is no sign of ink leakage, first-stage sign information indicating that there is a sign of ink leakage, second-stage sign information indicating that the sign of ink leakage is increased, and third-stage sign information indicating that there is a sign that ink will soon leak. In the following description, the first-stage sign information, the second-stage sign information, and the third-stage sign information may be collectively referred to as sign stage information.

In the first aspect relating to conductive properties, when the lower conductive wire 61C3 and the upper conductive wire 65C3 are in a non-conductive state, the leakage determination circuit 29C generates the no-sign information. When the lower conductive wire 61C3 and the upper conductive wire 65C3 are in a conductive state, the leakage determination circuit 29C generates the first-stage sign information. When the lower conductive wire 61C2 and the upper conductive wire 65C2 are in a conductive state, the leakage determination circuit 29C generates the second-stage sign information. In addition, when the lower conductive wire 61C1 and the upper conductive wire 65C1 are in a conductive state, the leakage determination circuit 29C generates the third-stage sign information. Similarly, in the second aspect relating to conductive properties, when the lower conductive wire 61C3 and the upper conductive wire 65C3 are in a conductive state, the leakage determination circuit 29C generates the no-sign information. When the lower conductive wire 61C3 and the upper conductive wire 65C3 are in a non-conductive state, the leakage determination circuit 29C generates the first-stage sign information. When the lower conductive wire 61C2 and the upper conductive wire 65C2 are in a non-conductive state, the leakage determination circuit 29C generates the second-stage sign information. Additionally, when the lower conductive wire 61C1 and the upper conductive wire 65C1 are in a non-conductive state, the leakage determination circuit 29C generates the third-stage sign information. The leakage determination circuit 29C transmits information indicating the degree of a sign of ink leakage to the control circuit 21C, as the determination information JIC.

The control circuit 21C functions as an acquisition section 71C, a determination section 73C, and a notification section 75C by executing the read control program PM2. The acquisition section 71C acquires the determination information JIC instead of the determination information JI.

The determination section 73C determines whether or not there is a liquid ejecting head 30C associated with the sign stage information by referring to the determination information JIC. For example, when the user U is notified of notification information CIC including the first-stage sign information or the second-stage sign information, the user U orders the liquid ejecting head 30C from the head manufacturer. Then, when the user U is notified of the notification information CIC including the third-stage sign information, the user U replaces the liquid ejecting head 30C with a new liquid ejecting head 30C acquired from the head manufacturer.

When the determination result of the determination section 73C is affirmative, the notification section 75C generates the notification information CIC based on the determination information JIC and transmits the generated notification information CIC to the processing apparatus 200. The notification information CIC is information regarding the liquid ejecting head 30C having a sign of ink leakage. Note that the notification information CIC includes information indicating the degree of a sign of ink leakage from the liquid ejecting head 30C. For example, when the determination information JIC includes the first-stage sign information, the notification information CIC includes a character string stating “There is a sign of ink leakage from the liquid ejecting head. Please consider replacing the liquid ejecting head”. In addition, when the determination information JIC includes the second-stage sign information, the notification information CIC includes a character string stating “The sign of ink leakage from the liquid ejecting head is increased. It is recommended to replace the liquid ejecting head”. When the determination information JIC includes the third-stage sign information, the notification information CIC includes a character string stating “There is a sign that ink will soon leak from the liquid ejecting head. It is recommended to promptly replace the liquid ejecting head”.

### 3-2. Summary of Fourth Embodiment

As described above, the liquid ejecting head 30C in the fourth embodiment includes the lower conductive wire 61C2 and the lower conductive wire 61C3 that are disposed at the first interface BF1 and that are disposed between the in-head supply flow path Rb and the lower conductive wire 61C1.

According to the fourth embodiment, a sign of ink leakage from the liquid ejecting head 30C can be detected in multiple stages. The user U can know the lifetime of the liquid ejecting head 30C in stages. Additionally, the user U can take measures corresponding to each piece of the notification information CIC based on the sign stage information. Specifically, the user U can use the liquid ejecting head 30C until immediately before the liquid ejecting head 30C fails, while securing a period of time for preparing a replacement liquid ejecting head 30C. For example, when the user U is notified of the notification information CIC including the first-stage sign information or the second-stage sign information, the user U orders the liquid ejecting head 30C from the head manufacturer. Then, when the user U is notified of the notification information CIC including the third-stage sign information, the user U replaces the liquid ejecting head 30C with the liquid ejecting head 30C acquired from the head manufacturer.

### 4. Modification Examples

Each of the aspects exemplified above can be variously modified. Specific modification aspects that can be applied to each of the aspects mentioned above will be exemplified below. Two or more aspects optionally selected from the following examples can be combined as appropriate within a range in which the aspects are not mutually contradictory.

### 4-1. First Modification Example

In each of the aspects mentioned above, the conductive wires provided in the detection mechanism 60 are disposed in both of the two flow path members bonded by the bonding portion GL, but the present disclosure is not limited thereto. For example, in the first aspect relating to conductive properties, a conductive wire provided in the detection mechanism 60 may be disposed in one of the two flow path members bonded by the bonding portion GL.

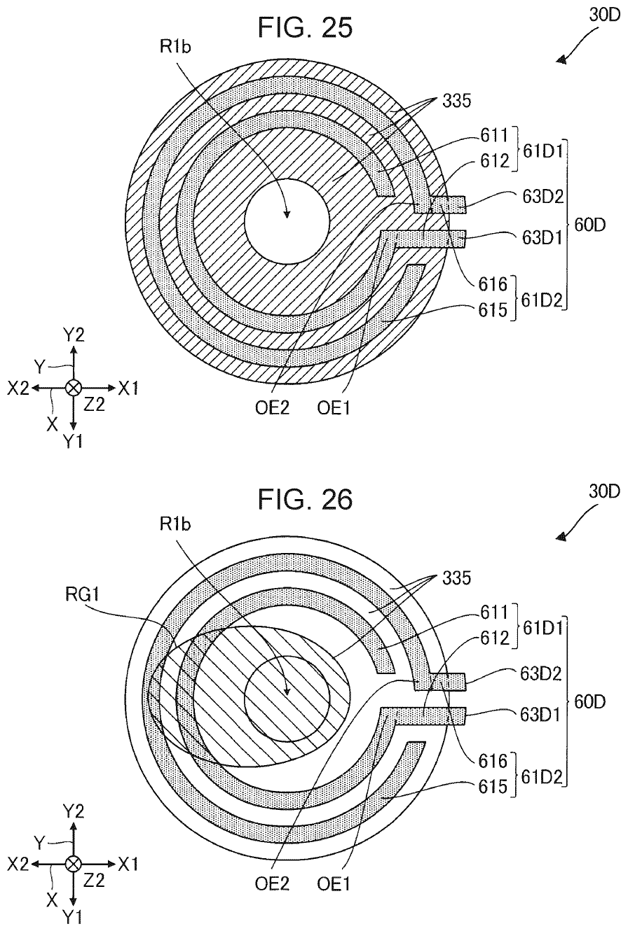

FIGS. 25 and 26 are views illustrating a detection mechanism 60D in a first modification example. A liquid ejecting head 30D in the first modification example includes a detection mechanism 60D instead of the detection mechanism 60. FIGS. 25 and 26 show a state in which the first interface BF1 of the liquid ejecting head 30D is viewed in the Z2 direction. In addition, FIG. 25 shows a state immediately after manufacture of the liquid ejecting head 30D. FIG. 26 shows a penetration range RG1 in which a part of the bonding portion GL57 is deteriorated and ink penetrates into the bonding portion GL57. Further, in FIG. 26, hatching applied to the case 335 is removed in order to facilitate identification of the penetration range RG1.

The detection mechanism 60D includes lower conductive wires 61D1 and 61D2 and lower wirings 63D1 and 63D2. The lower conductive wires 61D1 and 61D2 are disposed at the first interface BF1 so as to be spaced apart from each other. The lower wiring 63D1 functions as a lead-out wire of the lower conductive wire 61D1. The lower wiring 63D2 functions as a lead-out wire of the lower conductive wire 61D2. The lower wiring 63D1 and the lower wiring 63D2 extend in the direction along the Z-axis so as to extend along a wall surface of the case 335 that faces the X1 direction. The lower wirings 63D1 and 63D2 are coupled to the leakage determination circuit 29 via the flexible substrate 51 or the like.

The lower conductive wire 61D1 includes a first conductive wire portion 611 and a second conductive wire portion 612. The first conductive wire portion 611 is disposed so as to extend along the in-head supply flow path R1b. The first conductive wire portion 611 is formed in a C shape obtained by cutting out a part of a circle and includes a cutout in the X1 direction. The second conductive wire portion 612 is coupled to a coupling portion OE1, which is one end of the first conductive wire portion 611, and extends from the coupling portion OE1 in the X1 direction. An end portion of the second conductive wire portion 612 in the X1 direction is coupled to an end portion of the lower wiring 63D1 in the Z1 direction.

The lower conductive wire 61D2 includes a first conductive wire portion 615 and a second conductive wire portion 616. The first conductive wire portion 615 is disposed so as to extend along the in-head supply flow path R1b. The first conductive wire portion 615 is formed in a C shape obtained by cutting out a part of a circle and includes a cutout in the X1 direction. As understood from FIG. 25, the first conductive wire portion 611 is disposed between the in-head supply flow path R1b and the first conductive wire portion 615. The second conductive wire portion 612 is disposed to be inserted through the cutout of the first conductive wire portion 615. The second conductive wire portion 616 is coupled to a coupling portion OE2, which is one end of the first conductive wire portion 615, and extends from the coupling portion OE2 in the X1 direction. An end portion of the second conductive wire portion 616 in the X1 direction is coupled to an end portion of the lower wiring 63D2 in the Z1 direction.

In the first modification example, the lower conductive wire 61D1 and the lower conductive wire 61D2 correspond to a “first conductive wire”. When the lower conductive wire 61D1 is an example of a “first conductive wire”, the first conductive wire portion 611 corresponds to a “first conductive wire portion”, the second conductive wire portion 612 corresponds to a “second conductive wire portion”, and the coupling portion OE1 corresponds to a “coupling portion”. When the lower conductive wire 61D2 is an example of the “first conductive wire”, the first conductive wire portion 615 corresponds to the “first conductive wire portion”, the second conductive wire portion 616 corresponds to the “second conductive wire portion”, and the coupling portion OE2 corresponds to the “coupling portion”. Even when either the lower conductive wire 61D1 or the lower conductive wire 61D2 corresponds to the “first conductive wire”, the X1 direction is an example of a “direction away from the first flow path”.

The leakage determination circuit 29 in the first modification example determines whether the lower conductive wire 61D1 and the lower conductive wire 61D2 are in a conductive state or a non-conductive state. As shown in FIG. 25, in the initial state of the liquid ejecting head 30D, since the lower conductive wire 61D1 and the lower conductive wire 61D2 are disposed so as to be spaced apart from each other, the lower wiring 63D1 and the lower wiring 63D2 are in a non-conductive state. On the other hand, as shown in FIG. 26, when the bonding portion GL57 deteriorates and ink penetrates into the bonding portion GL57, the lower conductive wire 61D1 and the lower conductive wire 61D2 are electrically coupled via ink having conductive properties. Therefore, the lower conductive wire 61D1 and the lower conductive wire 61D2 are in a conductive state.

Hereinafter, assuming that the lower conductive wire 61D1 is an example of a “first conductive wire”, a summary of the first modification example will be described. In the detection mechanism 60D in the first modification example, in the first aspect relating to conductive properties, the lower conductive wire 61D1 includes the first conductive wire portion 611 that is disposed so as to extend along the in-head supply flow path R1b, and the second conductive wire portion 612 that is coupled to the coupling portion OE1 of the first conductive wire portion 611 and that extends from the coupling portion OE1 in the X1 direction away from the in-head supply flow path R1b.

According to the first modification example, the lower conductive wire 61D1 can be led out to the side surface of the case 335 by the second conductive wire portion 612 extending in the X1 direction from the coupling portion OE1, and unlike in the first embodiment, it is not necessary to penetrate the lower wiring 63 through the case 335, whereby manufacture of the liquid ejecting head 30D is facilitated.

In the first modification example, the second conductive wire portion 612 extends in the X1 direction, which is an example of a “direction away from the first flow path”, from the coupling portion OE1, but the extending direction is not limited to the X1 direction. For example, the second conductive wire portion 612 may extend from the coupling portion OE1 in a direction away from the in-head supply flow path Rib and in a direction in which a short circuit does not occur with the lower conductive wire 61D1.

Additionally, in the first modification example, the lower conductive wire 61D1 and the lower conductive wire 61D2 are disposed at the first interface BF1, but the two conductive wires may be disposed only at the second interface BF2 so as to be spaced apart from each other. Further, the two conductive wires may be respectively disposed at the first interface BF1 and the second interface BF2 so as to be spaced apart from each other. By respectively disposing the two conductive wires at the first interface BF1 and the second interface BF2 so as to be spaced apart from each other, as compared with an aspect in which the two conductive wires are disposed at only one of the first interface BF1 and the second interface BF2 so as to be spaced apart from each other, it is possible to suppress a situation in which a sign of ink leakage from the liquid ejecting head 30D cannot be detected when ink penetrates into the interface at which the two conductive wires are not disposed.

### 4-2. Second Modification Example

In the first to fourth embodiments, the lower conductive wire 61 corresponding to a “first conductive wire” is provided so as to extend along the in-head supply flow path Rib corresponding to a “first flow path”, but the present disclosure is not limited thereto. For example, the lower conductive wire 61 may be provided in any one direction or a plurality of directions with respect to the in-head supply flow path R1b.

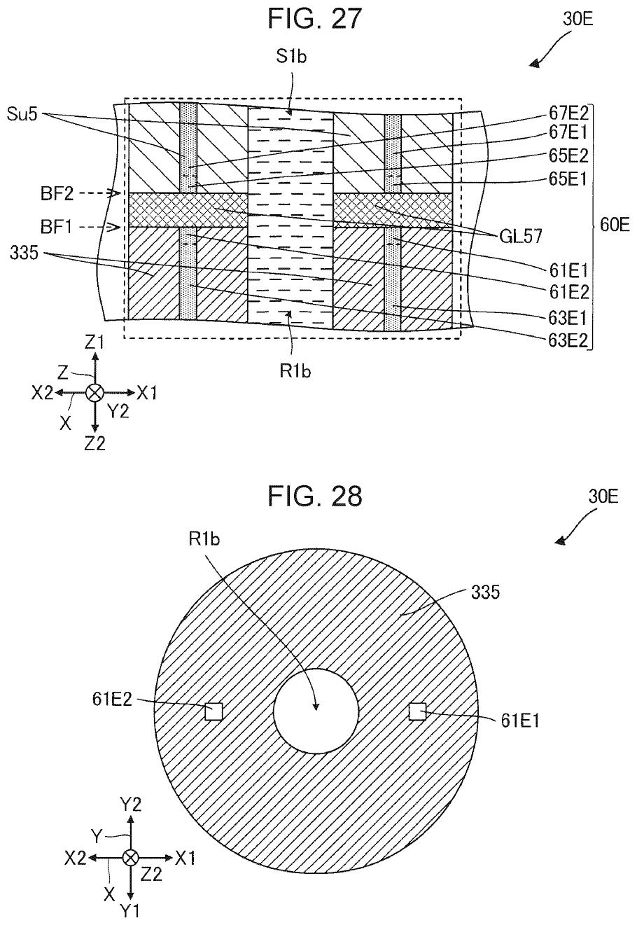

FIGS. 27 and 28 are views illustrating a detection mechanism 60E in a second modification example. A liquid ejecting head 30E in the second modification example includes the detection mechanism 60E instead of the detection mechanism 60. The detection mechanism 60E can be applied to both the first aspect relating to conductive properties and the second aspect relating to conductive properties, similarly to the detection mechanism 60 of the first embodiment. FIG. 27 shows the vicinity of the bonding portion GL57 of the liquid ejecting head 30E in an enlarged manner. FIG. 28 shows a state in which the first interface BF1 of the liquid ejecting head 30E is viewed in the Z2 direction.

The detection mechanism 60E includes lower conductive wires 61E1 and 61E2, lower wirings 63E1 and 63E2, upper conductive wires 65E1 and 65E2, and upper wirings 67E1 and 67E2. Hereinafter, the lower conductive wires 61E1 and 61E2 may be collectively referred to as a lower conductive wire 61E. In addition, the upper conductive wires 65E1 and 65E2 may be collectively referred to as an upper conductive wire 65E.

The lower conductive wires 61E1 and 61E2 are disposed at the first interface BF1. The upper conductive wires 65E1 and 65E2 are disposed at the second interface BF2. In plan view, the lower conductive wires 61E1 and 61E2 and the upper conductive wires 65E1 and 65E2 have a rectangular shape. The lower wirings 63E1 and 63E2 function as lead-out wires of the lower conductive wires 61E1 and 61E2, respectively. The lower wirings 63E1 and 63E2 penetrate through the case 335 in the direction along the Z-axis. The upper wirings 67E1 and 67E2 function as lead-out wires of the upper conductive wires 65E1 and 65E2, respectively. The upper wirings 67E1 and 67E2 penetrate through the flow path plate Su5 in the direction along the Z-axis.

As understood from FIGS. 27 and 28, the lower conductive wire 61E1 is disposed in the X1 direction with respect to the in-head supply flow path R1b. Additionally, the lower conductive wire 61E2 is disposed in the X2 direction with respect to the in-head supply flow path R1b. Further, a shortest distance from the in-head supply flow path R1b to the lower conductive wire 61E1 is substantially the same as a shortest distance from the in-head supply flow path R1b to the lower conductive wire 61E2. The upper conductive wire 65E1 is disposed in the X1 direction with respect to the in-structure supply flow path S1b.

In addition, the upper conductive wire 65E2 is disposed in the X2 direction with respect to the in-structure supply flow path S1b.

In the second modification example, similarly to the fourth embodiment, it is possible to detect a sign of ink leakage from the liquid ejecting head 30E in multiple stages. For example, it is assumed that the first aspect relating to conductive properties is applied. In the second modification example, the leakage determination circuit 29 generates the no-sign information when both the lower conductive wire 61E1 and the upper conductive wire 65E1, and the lower conductive wire 61E2 and the upper conductive wire 65E2 are in a non-conductive state, generates the first-stage sign information when one set of the two sets, that is, the lower conductive wires 61E and the upper conductive wires 65E, is in a conductive state, and generates the second-stage sign information when both sets of the two sets are in a conductive state.

In the second modification example, the lower conductive wires 61E are disposed in two directions with respect to the in-head supply flow path R1b, but the present disclosure is not limited thereto. For example, the lower conductive wires 61E may be disposed in the Y1 direction and the Y2 direction with respect to the in-head supply flow path R1b. Further, in the second modification example, shortest distances from the in-head supply flow path R1b to a plurality of lower conductive wires 61E are all the same, but may be different.

Additionally, when the second modification example is applied only to the first aspect relating to conductive properties, the lower conductive wire 61E may include a conductive wire portion extending in the direction away from the in-head supply flow path R1b, similarly to the first modification example.

### 4-3. Third Modification Example

In the first modification example, a sign of ink leakage from the liquid ejecting head 30D is detected by disposing two conductive wires provided in the detection mechanism 60D in one of the two flow path members bonded by the bonding portion GL, but a sign of ink leakage from the liquid ejecting head 30 can be detected by one conductive wire. A third modification example will be described below.

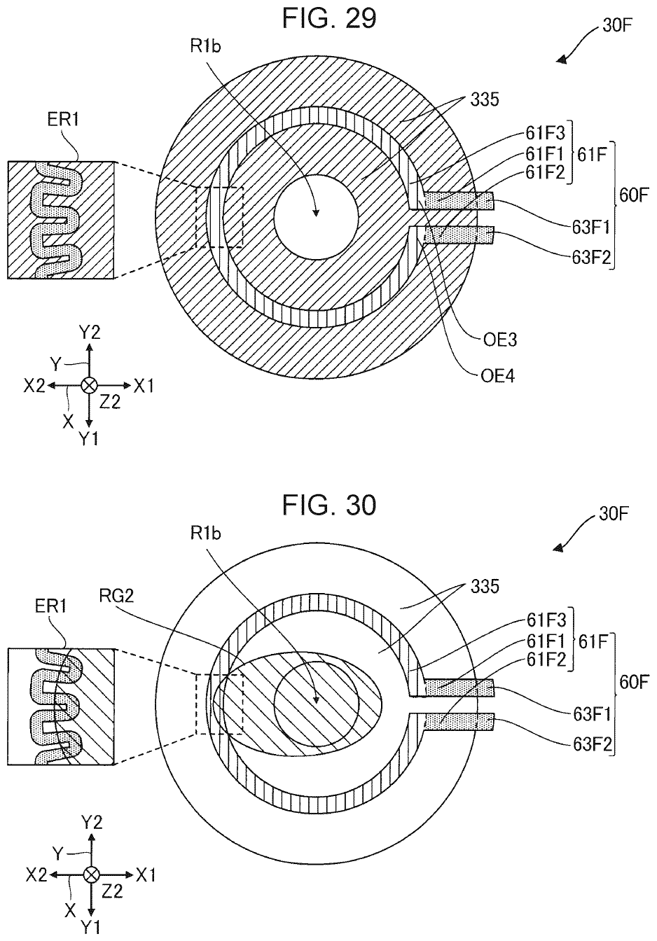

FIGS. 29 and 30 are views illustrating a detection mechanism 60F in the third modification example. A liquid ejecting head 30F in the third modification example includes the detection mechanism 60F instead of the detection mechanism 60. The detection mechanism 60F can be applied to the first aspect relating to conductive properties. FIGS. 29 and 30 show a state in which the first interface BF1 of the liquid ejecting head 30F is viewed in the Z2 direction. In addition, FIG. 29 shows the initial state of the liquid ejecting head 30F. FIG. 30 shows a penetration range RG2 in which a part of the bonding portion GL57 deteriorates and ink penetrates into the bonding portion GL57.

Further, in FIG. 30, hatching applied to the case 335 is removed in order to facilitate identification of the penetration range RG2.

The detection mechanism 60F includes a lower conductive wire 61F and lower wirings 63F1 and 63F2. The lower conductive wire 61F is disposed at the first interface BF1. The lower conductive wire 61F includes conductive wire portions 61F1, 61F2, and 61F3. The conductive wire portions 61F1 and 61F2 function as lead-out wires of the conductive wire portion 61F3. The conductive wire portions 61F1 and 61F2 extend in the direction along the X-axis. An end portion of the conductive wire portion 61F1 in the X2 direction is coupled to one end OE3 of the conductive wire portion 61F3. An end portion of the conductive wire portion 61F2 in the X2 direction is coupled to one end OE4 of the conductive wire portion 61F3. An end portion of the conductive wire portion 61F1 in the X1 direction is coupled to an end portion of the lower wiring 63F1 in the Z1 direction. An end portion of the conductive wire portion 61F2 in the X1 direction is coupled to an end portion of the lower wiring 63F2 in the Z1 direction. The lower wirings 63F1 and 63F2 function as lead-out wires of the lower conductive wire 61F. The lower wirings 63F1 and 63F2 extend in the direction along the Z-axis so as to extend along the wall surface of the case 335 in the X1 direction. The lower wirings 63F1 and 63F2 are coupled to the leakage determination circuit 29 via the flexible substrate 51 or the like.

In FIGS. 29 and 30, in order to prevent the drawings from being complicated, the shape of the conductive wire portion 61F3 is shown in a simplified manner. In FIGS. 29 and 30, vertical hatching is applied to portions where the wiring shape is simplified. The actual shape of the conductive wire portion 61F3 is a meandering shape in which an extending direction periodically changes, as shown in an enlarged region ER1 in which an end portion of the conductive wire portion 61F3 in the X2 direction is enlarged in FIGS. 29 and 30. The conductive wire portion 61F3 is disposed so as to surround the in-head supply flow path R1b while meandering.

The leakage determination circuit 29 in the third modification example determines whether or not there is a sign of ink leakage from the liquid ejecting head 30F based on a magnitude of a current between the lower wiring 63F1 and the lower wiring 63F2. In contrast to the initial state of the liquid ejecting head 30F as shown in FIG. 29, in a state in which the ink penetrates into the bonding portion GL57 as shown in FIG. 30, a part of the conductive wire portion 61F3 is short-circuited by the ink as shown in FIG. 30, and resistance between the lower wiring 63F1 and the lower wiring 63F2 decreases. Therefore, a current value between the lower wiring 63F1 and the lower wiring 63F2 in a state in which ink penetrates into the bonding portion GL57 is greater than a current value between the lower wiring 63F1 and the lower wiring 63F2 in the initial state of the liquid ejecting head 30F. Accordingly, the leakage determination circuit 29 in the third modification example measures the current value between the lower wiring 63F1 and the lower wiring 63F2. Then, the leakage determination circuit 29 in the third modification example generates information indicating that there is no sign of ink leakage when the measured current value is less than a predetermined threshold value, and generates information indicating that there is a sign of ink leakage when the measured current value is equal to or greater than the predetermined threshold value. The predetermined threshold value is set in advance by the head manufacturer based on experiments and experience.

According to the third modification example, even when one conductive wire provided in the detection mechanism 60F is disposed in one of the two flow path members bonded by the bonding portion GL, it is possible to detect a sign of ink leakage from the liquid ejecting head 30F based on the magnitude of the current of the lower conductive wires 61F.

### 4-4. Fourth Modification Example

In each of the aspects mentioned above, the detection mechanism 60 may be provided at two or more locations in the liquid ejecting head 30, as mentioned above. For simplification of description, taking the liquid ejecting head 30 as one example, the leakage determination circuit 29 generates the determination information JI in the fourth modification example, for each of two or more detection mechanisms 60 provided at two or more locations, based on a magnitude of a current of two conductive wires coupled to the detection mechanism 60 or a magnitude of a current of one conductive wire, and transmits the generated determination information JI to the control circuit 21. The determination information JI in the fourth modification example has information indicating whether or not there is a sign of ink leakage for each of the detection mechanisms 60 and information indicating a position where the detection mechanism 60 is provided. The control circuit 21 transmits the notification information CI in the fourth modification example to the processing apparatus 200. The notification information CI in the fourth modification example is information indicating a position where the detection mechanism 60 that detects a sign of ink leakage is provided. Then, the control circuit 210 provided in the processing apparatus 200 notifies the user U of the notification information CI in the fourth modification example. The notification information CI is, for example, a character string indicating a position in the liquid ejecting head 30 where there is a sign of ink leakage. For example, when ink penetrates into the bonding portion GL57, the notification information CI is “There is a sign of ink leakage from a coupling portion between the flow path structure and the head unit”.

Additionally, by providing two or more detection mechanisms 60 in the liquid ejecting head 30, the head manufacturer may replace a portion having a sign of ink leakage. For example, when the detection mechanisms 60 are provided in the flow path structure 33 in the liquid ejecting head 30 and each head unit Hn, it is assumed that a sign of ink leakage is detected from the detection mechanism 60 provided in the head unit Hn. In this case, the head manufacturer can extend the lifetime of the liquid ejecting head 30 by replacing the head unit Hn in which a sign of ink leakage is detected.

### 4-5. Fifth Modification Example

In each of the aspects mentioned above, the control circuit 21 functions as the acquisition section 71, the determination section 73, and the notification section 75, but may function as the acquisition section 71 and the determination section 73 without functioning as the notification section 75. For example, when a service support staff member of the head manufacturer visits the printer manufacturer or the user U and executes the series of processes shown in FIG. 17, the control circuit 21 need not function as the notification section 75. The service support staff member provides appropriate support based on the determination information JI. For example, when the determination information JI indicates that there is a sign of ink leakage in liquid ejecting head 30, the service support staff member may propose replacement of the liquid ejecting head 30 to the user U.

What is claimed is:

1. A liquid ejecting head comprising:
a first flow path member that constitutes a first flow path communicating with a nozzle that ejects liquid;
a second flow path member that constitutes a second flow path communicating with the first flow path;
a bonding portion that bonds the first flow path member and the second flow path member such that the first flow path and the second flow path are in liquid-tight communication; and
a first conductive wire that is disposed at a first interface between the first flow path member and the bonding portion so as to be spaced apart from the first flow path.

2. The liquid ejecting head according to claim 1, further comprising:
a second conductive wire that is disposed at the first interface and that is disposed between the first flow path and the first conductive wire.

3. The liquid ejecting head according to claim 1, wherein
the liquid ejected from the nozzle has conductive properties, and
the bonding portion has insulating properties.

4. The liquid ejecting head according to claim 3, wherein
the first conductive wire includes a first side and a second side along an extending direction of the first conductive wire,
the first side is disposed between the first flow path and the second side,
the first interface includes a first end,
the first conductive wire is disposed between the first end and the first flow path, and
a shortest distance from the first side to the first flow path is longer than a shortest distance from the first side to the first end.

5. The liquid ejecting head according to claim 4, wherein
a length obtained by subtracting a width of the first conductive wire from the shortest distance from the first side to the first end is longer than zero.

6. The liquid ejecting head according to claim 3, wherein
the first conductive wire includes
a first conductive wire portion that is disposed so as to extend along the first flow path, and
a second conductive wire portion that is coupled to a coupling portion of the first conductive wire portion and that extends from the coupling portion in a direction away from the first flow path.

7. The liquid ejecting head according to claim 1, wherein
the liquid ejected from the nozzle has insulating properties, and
the bonding portion has conductive properties.

8. The liquid ejecting head according to claim 7, wherein
the first conductive wire includes a first side and a second side along an extending direction of the first conductive wire,
the first side is disposed between the first flow path and the second side,
the first interface includes a first end,
the first conductive wire is disposed between the first end and the first flow path, and
a shortest distance from the second side to the first flow path is longer than a shortest distance from the second side to the first end.

9. The liquid ejecting head according to claim 8, wherein
the shortest distance from the second side to the first end is longer than zero.

10. The liquid ejecting head according to claim 3, further comprising:
a third conductive wire that is disposed at a second interface between the second flow path member and the bonding portion so as to be spaced apart from the second flow path.
